(19) United States
(12) Patent Application Publication
(10) Pub. No.: US 2025/0289480 A1
(43) Pub. Date: Sep. 18, 2025

(54) RAIL CONVEYOR SYSTEMS

(71) Applicant: FLSmidth A/S, Valby (DK)

(72) Inventors: Martin Lurie, Greenwood Village, CO (US); Jonathan Wegener, Greenwood Village, CO (US); Iavor Kostadinov, Greenwood Village, CO (US); Vladimir Svirsky, Greenwood Village, CO (US); Robert Corriveau, Greenwood Village, CO (US)

(21) Appl. No.: 18/861,203

(22) PCT Filed: Apr. 27, 2023
(86) PCT No.: PCT/IB2023/054388

§ 371 Date: Oct. 28, 2024

Related U.S. Application Data
(60) Provisional application No. 63/335,695, filed on Apr. 27, 2022.

(51) Int. Cl. B61B 13/00; B61B 5/02; B61D 15/00; B61F 9/00; B61F 15/20; B61G 5/00

(52) U.S. Cl. CPC B61B 13/00; B61B 5/02; B61D 15/00; B61F 9/00; B61F 15/20; B61G 5/00

(57) ABSTRACT

A rail conveyor system may include carriages with multiple cradles that are configured to support a carry belt. The carriages may be supported by and may travel along guide rails that extend along a longitudinal path. The guide rails may be supported by discrete frame modules that are longitudinally spaced apart. The frame modules may include at least slidable frame modules that are slidably attached to footings and expansion frame modules that include expansion gaps that permit the guide rails to thermally expand and contract longitudinally. The carriage may also include an anti-derailment device that greatly minimizes the risk of derailment.

### FIELD

The present disclosure generally pertains to rail conveyor systems for transporting bulk material over long distances, including frame modules, rail carriages, carriage wheels, and anti-derailment features of such rail conveyor systems.

### BACKGROUND

Rail conveyors for transporting bulk material are known in the prior art. Known rail conveyors typically employ a multitude of spaced carriages that travel along guide rails and support a continuous carry belt. However, in certain circumstances, known rail conveyors are prone to carriage derailment, experience unintended sag in the carry belt, require an unnecessary number of carriages, lack a failsafe design in case a wheel is lost, do not adequately account for the effects of thermal expansion, and fail to mitigate the effects of subsidence around support footings. Thus a need exists for rail conveyor systems that improve upon drawbacks such as these inherent in prior art rail conveyor systems.

### SUMMARY

In some examples, a rail conveyor system may include discrete frame modules that support guide rails that extend along a longitudinal path. Wheeled carriages with one or more (e.g., at least two) cradles may travel along the guide rails and support a carry belt that can be loaded with bulk material. The discrete frame modules may have a lower, return run and an upper, carry run. The frame modules may be longitudinally spaced apart so as to be interconnected only by guide rails and, in some cases, a third rail or an anti-derailment guide.

The third rail and the anti-derailment guides may be configured to cooperate with anti-derailment devices, wheels, and/or axles of the carriages to minimize the risk of derailment. Moreover, the frame modules may include a fixed frame module where frame members are securely fixed to both footings and the guide rails, a slidable frame module where frame members are securely fixed to the guide rails but can slide at least to some degree longitudinally relative to the footings, and expansion frame modules where frame members are securely fixed to the footings but are slidably coupled to the guide rails so that the guide rails can expand and contract at expansion joints. Sequencing the slidable frame modules such that expansion frame modules and slidable frame modules are disposed between fixed frame modules can minimize or even eliminate the disadvantages of thermal expansion on the guide rails.

A rail conveyor system (700) according to some embodiments may comprise guide rails that extend along a longitudinal path. The rail conveyor system (700) may also comprise carriages (100, 320, 322, 350, 352, 370, 418, 420, 422, 424, 478, 480, 482, 484, 740, 742, 744) that are supported by the guide rails and are configured to travel along the guide rails.

In some embodiments, at least one the carriages may include at least two cradles (124, 126). Each of the cradles (124, 126) may be configured to support a loaded and/or unloaded portion of a carry belt (746). By having more than one cradle, less carriages may need to be used, carriages may be spaced further apart, and portions of a carry belt (746) may be more adequately supported with less wear at contact points.

Some embodiments of a rail conveyor system (700) may comprise frame modules. The frame modules may be longitudinally spaced apart along the longitudinal path and they may be configured to support the guide rails.

In some embodiments of a rail conveyor system (700), the frame modules may have a lower return run (308, 338, 534, 538, 606, 754) and an upper carry run (316, 346, 614, 752).

Some embodiments of a rail conveyor system (700) may comprise a third rail (256, 306, 314, 344, 540, 542, 604). The third rail (256, 306, 314, 344, 540, 542, 604) may be configured to cooperate with one or more anti-derailment devices (122, 254, 200B) provided to the carriages, for example, to minimize the risk of derailment. In some embodiments, the third rail (256, 306, 314, 344, 540, 542, 604) may be configured to only cooperate with the one or more anti-derailment devices (122, 254, 200B) in the event of a carriage derailment or loss or detachment of one or more carriage wheels (212).

In some embodiments, of a rail conveyor system (700), a third rail (306) may be provided to and extend along at least a portion of a lower return run (308). A third rail (314) may be provided to and extend along at least a portion of an upper carry run (316).

In some embodiments, a third rail (256, 306, 314, 540, 542, 604) may provided between the guide rails.

A third rail (256, 306, 314, 344, 540, 542, 604) may be fixed to a bracket (270). The bracket (270) may be fixed to a lateral-extending member (272) of a frame that supports the two primary guide rails (302, 304, 360, 362, 532, 536, 602, 608, 610).

The rail conveyor system (700) may comprise an anti-derailment guide (400, 402, 404, 406, 408, 410, 412, 414, 460, 462, 464, 466, 468, 470, 472, 474) which is configured to cooperate with wheels (112, 112A, 112B, 112C, 112D), and/or axles (160, 162) of the carriages to minimize the risk of derailment.

Some embodiments of a rail conveyor system (700) may comprise footings (318, 360A, 360B, 546, 616, 718).

The frame modules may include a fixed frame module where frame members of the fixed frame module are securely fixed to both the footings (318, 360A, 360B, 546, 616, 718) and the guide rails. The frame modules may include a slidable frame module (300, 358, 426, 438, 486, 498, 520, 704, 706) where frame members of the slidable frame module (300, 358, 426, 438, 486, 498, 520, 704, 706) may be securely fixed to the guide rails but configured so that they can slide at least to some degree longitudinally relative to the footings (318, 360A, 360B, 546, 616, 718).

In some embodiments, the rail conveyor system (700) may comprise one or more slidable connections (544) which are configured to slidably attach the slidable frame module (520) to one or more footings (546) that are secured to, planted in, and/or staked to the ground.

In some embodiments, the frame modules may include an expansion frame module (330, 428, 488, 600, 702). Frame members of the expansion frame module may be securely fixed to the footings (318, 360A, 360B, 546, 616, 718) but slidably coupled to the guide rails so that the guide rails can expand and contract at expansion joints (430, 432, 434, 436, 490, 492, 494, 496, 618, 620, 622).

In some embodiments, the frame modules may comprise fixed frame modules, slidable frame modules (300, 358, 426, 438, 486, 498, 520, 704, 706), and expansion frame modules (330, 428, 488, 600, 702). The frame modules may be sequenced such that one or more of expansion frame modules and/or slidable frame modules may be disposed between fixed frame modules to accommodate thermal expansion of the guide rails.

In some embodiments, a rail conveyor system (700), at least one of the carriages (100) may comprise one or more outrigger brackets (200A, 200B, 200C, 200D).

The one or more outrigger brackets (200A, 200B, 200C, 200D) may be provided with a slider pad (202) positioned adjacent a location where a wheel (112) of said one of the carriages (100) contacts one of the guide rails. The slider pad (202) may be configured to reduce the risk of carriage derailment in the event the wheel (112) becomes detached from said one of the carriages (100).

In some embodiments, the one or more outrigger brackets (200A, 200B, 200C, 200D) may be provided with a lateral wheel (204). The lateral wheel (204) may be configured, at least through some sections of track, to roll along at least one of the guide rails (e.g., on an inner or outer side surface thereof, without limitation) and/or maintain a lateral position of a carriage relative to said at least one of the guide rails, particularly as the carriage travels through curves.

The one or more outrigger brackets (200A, 200B, 200C, 200D) may be provided between wheels (212) on one or both sides of said at least one of the carriages (100), for example, along a first (104) and/or second (106) longitudinal member of a frame (102).

The rail conveyor system (700) may comprise a cable (114, 380) coupled to and/or extending between adjacent carriages.

One or more safety springs (176) may be attached to the cable (114, 380). A safety spring may be configured to provide a “buffer” (e.g., a slack reduction or tension buffer) throughout a turnaround loop (789) and/or help maintain a proper amount of tension between carriages without pulling the carriages out of the turnaround loop (789) (or off of the guide rails).

In some embodiments, the cable may comprise an elasticity sufficient to maintain a positive cable tension in the cable (114, 380) in a turnaround loop (789).

In some embodiments, the rail conveyor system (700) may comprise an arrangement of one or more tension or compression springs with the cable (114, 380), for example, to maintain a positive cable tension in the cable (114, 380) in a turnaround loop (789).

In some embodiments, at least one of the carriages may comprise at least one wheel (112) having a core section (220) and a flanged section (222). The core section (220) may comprise a conical face (224) configured to enable the wheel (112) to spin at different rates, for example, when the at least one of the carriages travels through a curve along portions of the rail conveyor system (700) where the guide rails are curved.

The flanged section (222) of the wheel (112) may include a composite annulus (226). The composite annulus (226) may be sandwiched between the core section (220) and a steel backing ring (228). The composite annulus (226) may comprise a material having a coefficient of friction with steel which is substantially lower than a coefficient of friction between steel and steel. This may prevent the flanged section (222) from climbing up a guide rail. It may also discourage carriage derailment.

In some embodiments of a rail conveyor system (700), the composite annulus (226) may be joined to the flanged section (222) at a radial extremity of where the core section (220) terminates. The composite annulus (226) may, in some embodiments, be configured to have a face that is smoothly contiguous with an annular radius, fillet, blend, or curved transition surface that extends between the core section (220) and the flanged section (222).

The composite annulus (226) can comprise an outer diameter that is enlarged relative to the outer diameter of the core section (220), for example, to an extent that that the flanged section (222) projects below an enlarged upper rail head portion (657) of at least one of the guide rails.

A rail conveyor system (700) in accordance with the invention may comprise an upper sliding member (652, 664A). The upper sliding member (652, 664A) may be provided between a clamp body (648) of a clip (640) and one of the guide rails (608A). The upper sliding member (652, 664A) may comprise at least two separate components contacting each other at a low-friction sliding surface defined therebetween.

The upper sliding member (652, 664A) may comprise a polymeric (e.g., UHMWPE or similar) material and/or a metallic material. The material may be configured with properties for reducing resistance to sliding against the guide rails. The material may comprise a coefficient of friction which is less than the coefficient of friction of the material of the guide rails.

A rail conveyor system (700) according to certain embodiments may comprise a base sliding member (652). The base sliding member (652) may be provided below a base (656) of at least one of the guide rails (608A). The base sliding member (654, 664A) may comprise at least two separate components contacting each other, for example, at a low-friction sliding surface defined therebetween.

In some embodiments, the base sliding member (654, 664A) may comprise a polymeric (e.g., UHMWPE or similar) and/or metallic material. The material may be configured with properties for reducing resistance to sliding against the guide rails. The material may comprise a coefficient of friction which is less than the coefficient of friction of the material of the guide rails.

In some embodiments of a rail conveyor system (700), some of the carriages (e.g., in an upper carry run) may be supported on upper guide rails (302, 304) and travel above other ones of the carriages which are supported on lower guide rails (310, 312) (e.g., in a lower return run).

In any embodiment, dampening means (170) may be optionally provided to at least one of the carriages. In some embodiments, at least one of the carriages may comprise an axle beam (160) through which an axle (162) extends. In some embodiments, the axle beam (160) may support first (104) and second (106) longitudinal members of a carriage frame (102) by means of damping means (170) interposed between the axle beam (160) and the first (104) and second (106) longitudinal members. In some embodiments, at least one of the carriages may comprise a live axle (162) that rotates with wheels thereon. In some embodiments, at least one of the carriages may comprise a dead shaft axle (162) that does not rotate. The dead shaft axle (162) may support first (104) and second (106) longitudinal members of a carriage frame (102) by means of damping means (170). The damping means may be interposed between the dead shaft axle (162) and the first (104) and second (106) longitudinal members.

Carriages may each be identical or share similar features within a rail conveyor system (700). Alternatively, some carriages within a rail conveyor system (700) may be dissimilar with some having different (or omitted) features from other carriages.

In some embodiments of a rail conveyor system (700), at least a portion of a carry belt (746) may be supported by idlers (748). The idlers (748) may be provided in an area where a portion of the carry belt (746) is in transition between being supported by a carriage (740) and being supported by an end idler. The idlers (748) may be provided in an area downstream of where carriages (740, 742, 744) are lowered down away from a loaded portion of the carry belt (746) along an upper carry run. The idlers (748) may be top-supported and/or have a low profile.

The rail conveyor system (700) may, in some embodiments, comprise a guard (780). The guard (780) may be configured to cover a nip point between advancing wheels (112) of the carriages (112) and at least one of the guide rails. One or more (e.g., a plurality) of guards may be provided to the rail conveyor system (700). A guard (780) may be provided as a guard panel spanning upward from a level near a base (656) of said at least one of the guide rails up to at least a wheel axle (162) on one of the carriages, and/or up to a top of a wheel (112) on one of the carriages.

In some embodiments of a rail conveyor system (700) frame modules may be interconnected by the guide rails, for example, such that the guide rails extend between frame modules and/or such that the guide rails bridge gaps between ends of adjacent frame modules. The gaps may extend for an unsupported section length (301, 701).

In some embodiments, a third rail (256, 306, 314, 344, 540, 542, 604) of the rail conveyor system (700) may extend for at least a portion of the length of the guide rails either continuously or discontinuously.

In some embodiments, one or more cradles (124, 126) of the carriages may be supported along longitudinal members (104, 106) of a carriage frame (102). A plurality of cradles (124, 126) on a carriage may be longitudinally spaced apart from one another in relation to a longitudinal direction (LD).

In some embodiments, at least one of the cradles (124, 126) may be longitudinally spaced apart from and/or longitudinally offset from a first (108) and/or second crossmember (110), in relation to a longitudinal direction (LD).

In some embodiments, a first one (124) of the cradles (124, 126) may be longitudinally spaced apart from and/or longitudinally offset from a first crossmember (108), in relation to a longitudinal direction (LD).

In some embodiments, a second one (126) of the cradles (124, 126) may be longitudinally spaced apart from and/or longitudinally offset from a second crossmember (110) provided to the carriage, in relation to a longitudinal direction (LD). In some embodiments of a rail conveyor system (700), one or more cradles (124, 126) may be offset from an adjacent wheel axis or axis of an adjacent carriage axle (162), for example, by a distance which is sufficient to provide one or more lateral wheels (204) or slider pads (202) in substantial alignment with the cradles (124, 126) without interference from wheels (112) or other carriage portions. One or more cradles (124, 126) may be offset from an adjacent wheel axis or axis of an adjacent carriage axle (162) by a distance which is sufficient to expose a gauge-side surface of an upper rail head portion (657) of guide rails to lateral wheels (204).

In some embodiments, a rail conveyor system (700) may comprise guide rails that extend along a longitudinal path; and carriages (100, 320, 322, 350, 352, 370, 418, 420, 422, 424, 478, 480, 482, 484, 740, 742, 744) that are supported by the guide rails and are configured to travel along the guide rails. The rail conveyor system (700) may be comprise frame modules wherein at least two of the frame modules may be longitudinally spaced apart along the longitudinal path. The frame modules may be interconnected by the guide rails and/or and/or the frame modules may support the guide rails.

The frame modules may be interconnected by the guide rails such that the guide rails extend between frame modules and/or such that they bridge gaps between ends of adjacent frame modules.

A rail conveyor system (700) according to some embodiments may comprise a ramp (750) provided to an upper carry run (316, 346, 614, 752) which is defined by an elevation change of upper guide rails provided to the upper carry run (316, 346, 614, 752). The ramp (750) may be configured to drop the carriages away from a loaded upper portion of a carry belt (746).

rail conveyor system (700) according to some embodiments may comprise a ramp (778) provided to a lower return run (308, 338, 606, 754) which is defined by an elevation change of lower guide rails provided to the lower return run (308, 338, 606, 754). The ramp (778) may be configured to raise the carriages towards an unloaded lower portion of a carry belt (746) as they move away from a turnaround loop (789).

A spacing may be provided between adjacent frame modules. The spacing may be configured to allow a predetermined amount of differential settlement between the adjacent frame modules. A spacing provided between adjacent frame modules may be configured to accommodate a deflection of at least one of the guide rails spanning therebetween. A spacing between adjacent frame modules may be configured to allow at least some deflection of at least one of the guide rails and/or accommodate a vertical and/or horizontal curvature of at least one of the guide rails.

In some embodiments of the rail conveyor system (700) at least one of the frame modules may comprise a set of two or more lateral members (526). The lateral members (526) may be configured to support the guide rails. A spacing provided between the lateral members (526) measured in a longitudinal direction (LD) may be configured to allow one more of the guide rails to conform elastically to a vertical and/or horizontal curvature in the longitudinal direction (LD).

At least one of the lateral members (526) may, in some embodiments, comprise adjustment means. The at least one of the lateral members (526) may be configured to be adjusted relative to other components of said at least one of the frame modules. The adjustment means may be provided adjacent to where said at least one of the lateral members (526) joins another portion of said at least one of the frame modules. The adjustment means may be provided adjacent to a footing (546).

The adjustment means may be configured to provide a range of vertical adjustment between a portion of said at least one of the frame modules and said at least one of the lateral members (526). Accordingly, the range of vertical adjustment of the adjustment means may sufficiently accommodate an offset of one or more of the guide rails due to a vertical and/or horizontal curvature of said one or more of the guide rails in the longitudinal direction (LD).

The adjustment means may comprise height-setting means selected from the group consisting of: a slotted connection, a tongue that is sandwiched between plates, one or more jacks, or one or more adjustable brackets, without limitation.

In some embodiments of a rail conveyor system (700), at least one (608B) of the guide rails may be slidably retained to a lateral member (646), for example, using a clip (640). A clip (640) may be provided on opposite sides of the at least one (608B) of the guide rails.

The clip (640) may comprise a clamp body (648), one or more fasteners (650), and an upper sliding member (652). The rail conveyor system (700) may comprise a base sliding member (654) which is disposed above the lateral member (646) and below a base (656) of the at least one (608B) of the guide rails. The base sliding member (654) may be arranged and/or configured such that the base (656) is slidably retained to the lateral member (646). The base sliding member (654) may be arranged and/or configured such that sliding may occur between the lateral member (646) and base (656).

In some embodiments, a length of at least one of the carriages may be between approximately 1.30 and approximately 2.5 times its width.

In some embodiments, a longitudinal member (104, 106) of a frame (102) of least one of the carriages may be more than approximately 1.3 times the length of a crossmember (108, 110) of the frame (102).

In some embodiments, the longitudinal member (104, 106) may be more than approximately 1.50, 1.75, 2.00, 2.25, or 2.50 times the length of a crossmember (108, 110) on the frame (102).

One or more of the carriages may include one or more bumpers (118, 120) at a front (116) portion thereof. A plurality of bumpers (118, 120) may be provided to a single carriage. A bumper(s) (118, 120) may be configured to prevent the wheels 112A, 112B, 112C, 112D or the frame (1020 of a carriage from snagging on vertical structural columns. One or more bumpers may be provided adjacent ends of longitudinal members (104, 106) of a frame (102) of one of the carriages.

In some embodiments of a rail conveyor system (700), guide rails may be supported on frame modules (358, 300, 330), including at least two adjacent frame modules being spaced apart from each other in a longitudinal direction (LD) such that a gap exists between respective ends of the at least two adjacent frame modules. A portion of one of the guide rails at one of the gaps between the at least two adjacent frame modules may comprise an unsupported section length (701). The unsupported section length (701) may be within ±20% of a distance extending between guide rail support beams (526) on at least one of the adjacent frame modules. The distance extending between guide rail support beams (526) may be measured in the longitudinal direction (LD).

In some embodiments, the unsupported section length (701) may be greater than 5 times a section height (659) of a guide rail (340, 342). In some embodiments, the unsupported section length (701) may be greater than 10 times the section height (659) of a guide rail (340, 342). In some embodiments, the unsupported section length (701) may be greater than 20 times the section height (659) of a guide rail (340, 342). In some embodiments, the unsupported section length (701) may be greater than 30 times the section height (659) of a guide rail (340, 342).

### BRIEF DESCRIPTION OF THE DRAWINGS

FIG. 1A is a top view of an example carriage.

FIG. 1B is a perspective view of the example carriage of FIG. 1A.

FIG. 1C is a rear view of the example carriage of FIGS. 1A and 1B.

FIG. 1D is a side view of the example carriage of FIGS. 1A-1C.

FIG. 2A is a top view of a portion of an example cradle.

FIG. 2B is a perspective view of the example cradle of FIG. 2A.

FIG. 2C is a rear view of the example cradle of FIGS. 2A and 2B.

FIG. 2D is a side view of the example cradle of FIGS. 2A-2C.

FIG. 3A is a perspective view of an example crossmember of a carriage.

FIG. 3B is a rear view of the example crossmember of FIG. 3A.

FIG. 3C is a top view of the example crossmember of FIGS. 3A and 3B.

FIG. 3D is a sectional view taken across line A-A in FIG. 3B of the example crossmember.

FIG. 3E is a sectional view taken across line B-B in FIG. 3B of the example crossmember.

FIG. 4A is a perspective view of an example safety spring that can be used to attach a cable to a carriage.

FIG. 4B is a top view of the example safety spring of FIG. 4A.

FIG. 4C is a side view of the example safety spring of FIGS. 4A and 4B.

FIG. 5A is a perspective view of an example outrigger bracket with a slider pad.

FIG. 5B is a top view of the example outrigger bracket of FIG. 5A.

FIG. 5C is a rear view of the example outrigger bracket of FIGS. 5A and 5B.

FIG. 5D is a side view of the example outrigger bracket of FIGS. 5A-5C.

FIG. 6A is a perspective view of an example wheel for a carriage.

FIG. 6B is a side view of the example wheel, with several constituent components of the wheel in hidden view.

FIG. 6C is another perspective view of the example wheel.

FIG. 6D is a front view of the example wheel.

FIG. 6E is a side view of the example wheel.

FIG. 6F is a back view of the example wheel.

FIG. 7A is a perspective view of an example anti-derailment device for a carriage.

FIG. 7B is another perspective view of the example anti-derailment device.

FIG. 7C is a top view of the example anti-derailment device.

FIG. 7D is a right side view of the example anti-derailment device.

FIG. 7E is a back view of the example anti-derailment device.

FIG. 7F is a left side view of the example anti-derailment device.

FIG. 8A is a perspective view of an example bracket for supporting a third rail.

FIG. 8B is a top view of the example bracket of FIG. 8A.

FIG. 8C is a rear view of the example bracket of FIGS. 8A and 8B.

FIG. 8D is a side view of the example bracket of FIGS. 8A-8C.

FIG. 9 is a rear view of an example slidable frame module with third rails disposed on a lower, return run and on an upper, carry run.

FIG. 10 is a rear view of an example expansion frame module with third rails disposed on a lower, return run and on an upper, carry run.

FIG. 11A is a top view of an expansion frame module disposed next to two slidable frame modules.

FIG. 11B is a side view of the expansion frame module and the two slidable frame modules of FIG. 11A.

FIG. 12 is a perspective view of another example carriage.

FIG. 13A is a perspective view of an example anti-derailment guide that extends above a carriage wheel.

FIG. 13B is a rear view of a slidable frame module that employs the type of anti-derailment guide shown in FIG. 13A.

FIG. 13C is a rear view of an expansion frame module that employs the type of anti-derailment guide shown in FIG. 13A.

FIG. 14 is a perspective view of an example expansion frame module that utilizes the type of anti-derailment guide shown in FIGS. 13A-13C.

FIG. 15 is a perspective view of an example slidable frame module that utilizes the type of anti-derailment guide shown in FIGS. 13A-13C.

FIG. 16A is a top view of an expansion frame module positioned next to two slidable frame modules, all of which employ anti-derailment guides.

FIG. 16B is a side view of the arrangement shown in FIG. 16A.

FIG. 17A is a perspective view of another example anti-derailment guide that extends above a protruding portion of an axle.

FIG. 17B is a rear view of a slidable frame module that employs the type of anti-derailment guide shown in FIG. 17A.

FIG. 17C is a rear view of an expansion frame module that employs the type of anti-derailment guide shown in FIG. 17A.

FIG. 18 is a perspective view of an example expansion frame module that utilizes the type of anti-derailment guide shown in FIGS. 17A-17C.

FIG. 19 is a perspective view of an example slidable frame module that utilizes the type of anti-derailment guide shown in FIGS. 17A-17C.

FIG. 20A is a top view of an expansion frame module positioned next to two slidable frame modules, all of which employ the type of anti-derailment guides shown in FIGS. 17A-17C.

FIG. 20B is a side view of the arrangement shown in FIG. 20A.

FIG. 21A is a top view of an example slidable frame module.

FIG. 21B is a side view of the example slidable frame module of FIG. 21A.

FIG. 22A is a perspective view of an example slidable connection between a footing and frame members.

FIG. 22B is a top view of the example slidable connection of FIG. 22A.

FIG. 22C is a side view of the example slidable connection of FIGS. 22A and 22B.

FIG. 22D is a rear view of the example slidable connection of FIGS. 22A-22C.

FIG. 23A is top view of an example expansion frame module.

FIG. 23B is a side view of the example expansion frame module of FIG. 23A.

FIG. 24A shows a perspective view of a first clip that can be used to slidably secure a guide rail to a frame member.

FIG. 24B is a top view showing several of the first clips of FIG. 24A.

FIG. 24C is a side view showing several of the first clips of FIG. 24A.

FIG. 24D is a sectional view through two of the example first clips.

FIG. 25A shows a perspective view of a second clip that can be used to slidably secure a guide rail to a frame member.

FIG. 25B is a top view showing several of the second clips of FIG. 25A.

FIG. 25C is a side view showing several of the second clips of FIG. 25A.

FIG. 25D is a sectional view through two of the example second clips.

FIG. 26A is a perspective view of an example third clip.

FIG. 26B is a top view of the example third clip.

FIG. 26C is a side view of the example third clip.

FIG. 26D is a sectional view through the example third clip.

FIG. 27A is a perspective view of an example fourth clip.

FIG. 27B is a top view of the example fourth clip.

FIG. 27C is a side view of the example fourth clip.

FIG. 27D is a sectional view through the example fourth clip.

FIG. 28A is a top view of several example frame modules.

FIG. 28B is a side view of the frame modules shown in FIG. 28A.

FIG. 29A is a side view illustrating several frame modules with a ramp rejoining carriages with a loaded carry belt on a carry run.

FIG. 29B is a rear view of the frame modules, carriages, and ramp from FIG. 29A.

FIG. 30A is a side view illustrating several frame modules with a ramp rejoining carriages with an empty carry belt on a return run.

FIG. 30B is a rear view of the frame modules, carriages, and ramp from FIG. 30A.

FIG. 31 is a side perspective view of an example ramp rejoining carriages with a loaded carry belt.

FIG. 32 is a side perspective view of an example ramp rejoining carriages with an empty carry belt.

FIG. 33A is a partial cutaway isometric view of a rail conveyor system according to a non-limiting embodiment which employs a number of guards provided thereto for safety.

FIG. 33B shows two guards according to a non-limiting embodiment, clearly depicting inner (left of figure) and outer (right of figure) faces.

FIG. 33C is a side perspective view of a rail conveyor system showing the guards depicted in FIGS. 33A and 33B being deployed along one or more side portions of the rail conveyor system and shielding nip areas between carriage wheels and guide rails for both an upper carry run and a lower return run.

FIG. 33D is an end perspective view of FIG. 33A.

FIG. 33E is a side perspective view of demonstrating select portions of a rail conveyor being protected by one or more of the guards depicted in 33B.

### DETAILED DESCRIPTION

Although certain example methods and apparatuses are described herein, the scope of coverage of this patent is not limited thereto. On the contrary, this patent covers all methods, apparatuses, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language.

Similarly, it should be understood that the steps of any method claim need not necessarily be performed in the order in which they are recited, unless so required by the context of the claims. In addition, all references to one skilled in the art shall be understood to refer to one having ordinary skill in the art. With respect to the drawings, it should be understood that not all components are drawn to scale. Furthermore, those having ordinary skill in the art will understand that the various examples disclosed herein should not be considered in isolation. Rather, those with ordinary skill in the art will readily understand that the disclosure relating to some examples may be combined with and/or equally applicable to the disclosure relating to other examples. Finally, it should be understood that, at least in certain contexts, the term “vertical” may mean upright relative to another object such as a frame or a carriage even though the frame or carriage is inclined.

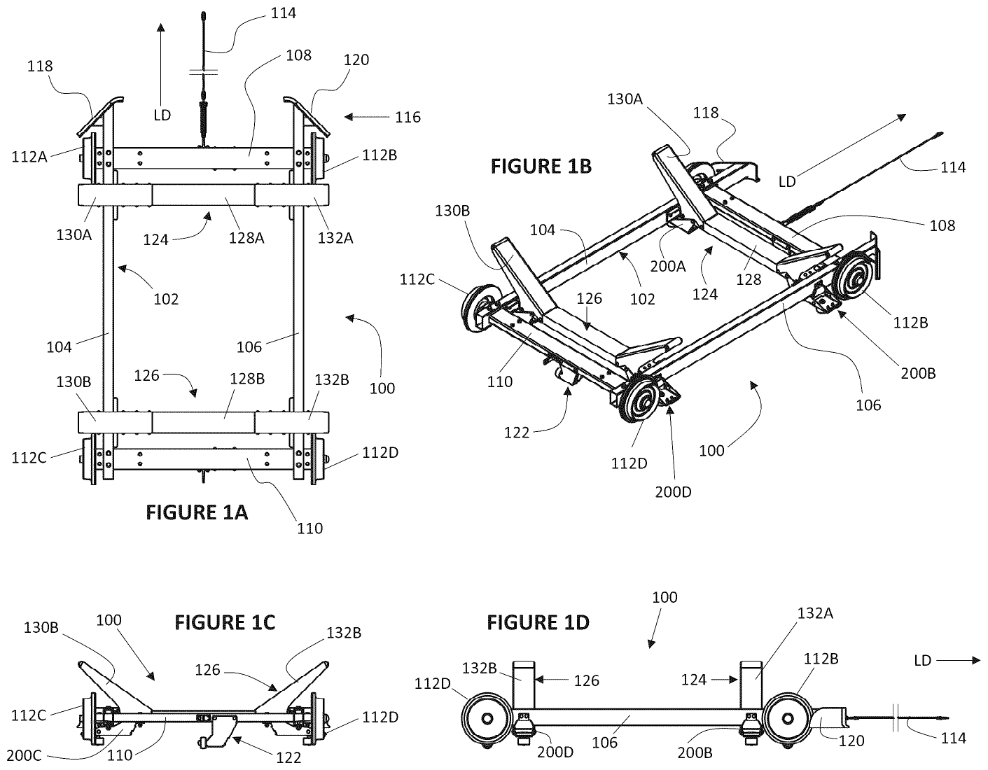

FIGS. 1A-1D show an example carriage 100 that is configured to travel along guide rails and support a carry belt that contains bulk material. As shown in FIGS. 1A, 1B, and 1D, the carriage 100 is configured to travel in a longitudinal direction LD along a longitudinal extent of the guide rails. The carriage 100 may include a frame 102 that is generally rectangular and includes a first longitudinal member 104, a second longitudinal member 106, a first crossmember 108, and a second crossmember 110 that are fixed to one another by fasteners, welds, or the like. Based on the longitudinal members 104, 106 and the crossmembers 108, 110, the carriage 100 may be at least 1.30, 1.50, 1.75, 2.00, 2.25, or even 2.50 times as long as the carriage 100 is wide, which helps the carriage 100 resist crabbing on guide rails and which reduces the total number of carriages required in a rail conveyor system. The carriage 100 shown here includes four wheels 112A, 112B, 112C, 112D, as described in more detail below. The carriage 100 may be towed and, in some cases, spaced apart from adjacent carriages via a cable 114. In many cases, though, the carry belt may be driven, and friction between the carry belt and the carriage 100 causes the carriage 100 to move with the carry belt. In such cases, the primary purpose of the cable 114, at least outside of turnaround loops, may be to space the carriages longitudinally.

At a front 116 of the carriage 100, bumpers 118, 120 may be disposed at ends of the longitudinal members 104, 106 to prevent the wheels 112A, 112B, 112C, 112D or the frame 102 from snagging vertical structural columns that support the guide rail in case of partial derailment. In other words, in the event that the carriage 100 is derailed, the bumpers 118, 120 can help deflect the carriage 100 advantageously back towards the guide rails and prevent a portion of the carriage 100 from snagging structural supports. As can be seen in the top view in FIG. 1A in particular, the bumpers 118, 120 can be arranged transverse to the longitudinal members 104, 106, such as at 35, 40, 45, 50, or 55 degrees relative to the longitudinal members 104, 106, for example. The bumpers 118, 120 may also prevent branches, debris, or even limbs of workers from inadvertently coming into contact with the wheels 112 of a moving carriage.

Alternatively or additionally, guards running longitudinally along the frame that supports the guide rails may serve the same purpose. One having ordinary skill in the art will also appreciate that at least a portion of the bumpers 118, 120, such as the forwardmost portion, for instance, may be rounded so as to decrease the likelihood of the bumpers 118, 120 snagging on objects.

As will be explained further below, the carriage 100 may also include an anti-derailment device 122 that is fixed to the second crossmember 110. The anti-derailment device 122 may be configured to engage or to selectively engage with a third rail and prevent derailment of the carriage 100. The anti-derailment device 122 may alternatively be disposed on the first crossmember 108. In still other examples, carriages may employ more than one anti-derailment device, such as where an anti-derailment device is disposed on each of the crossmembers, for instance.

Furthermore, the carriage 100 shown in the example here includes a first cradle 124 and a second cradle 126. The first and second cradles 124, 126 are configured to support a carry belt that contains bulk material. The example first and second cradles 124, 126 are supported along the longitudinal members 104, 106 and are longitudinally spaced apart from the first and second crossmembers 108, 110. Offsetting the cradles 124, 126 longitudinally from the crossmembers 108, 110 prevents the wheels 112 from interfering with or intruding into space that is occupied by the cradles 124, 126. In other examples, however, the first and second cradles 124, 126 may be integrated with or disposed directly above the first and second crossmembers 108, 110.

The first cradle 124 may include a base 128A with upward extending segments 130A, 132A on opposing lateral sides of the base 128A. In some implementations, the base 128A may be integral with the upward extending segments 130A, 132A. In other implementations, the base 128A and the upward extending segments 130A, 132A may be independent components that are fastened together. Likewise, the second cradle 126 may include a base 128B with upward extending segments 130B, 132B on opposing lateral sides of the base 128B. In some cases, the base 128 and the upward extending segments 130, 132 may have planar surfaces that are configured to contact a carry belt. Moreover, the upward extending segments 130, 132 may extend transversely relative to the base 128 and/or to the crossmembers 108, 110.

For example and without limitation, the upward extending segments 130, 132 may be disposed relative to the base 128 at an angle between 30° and 60°, at an angle between 40° and 50°, at an angle between 20° and 30°, at an angle between 50° and 60°, or at an angle between 60° and 70°. The upward extending segments 130, 132 may in some cases extend laterally beyond the extent of the wheels 112. In other cases, though, the upward extending segments 130, 132 may terminate directly above the wheels 112 or even laterally short of the wheels 112. In some examples, the upward extending segments 130, 132 may have cutouts to minimize weight and/or to reduce wind resistance, particularly in higher-speed applications.

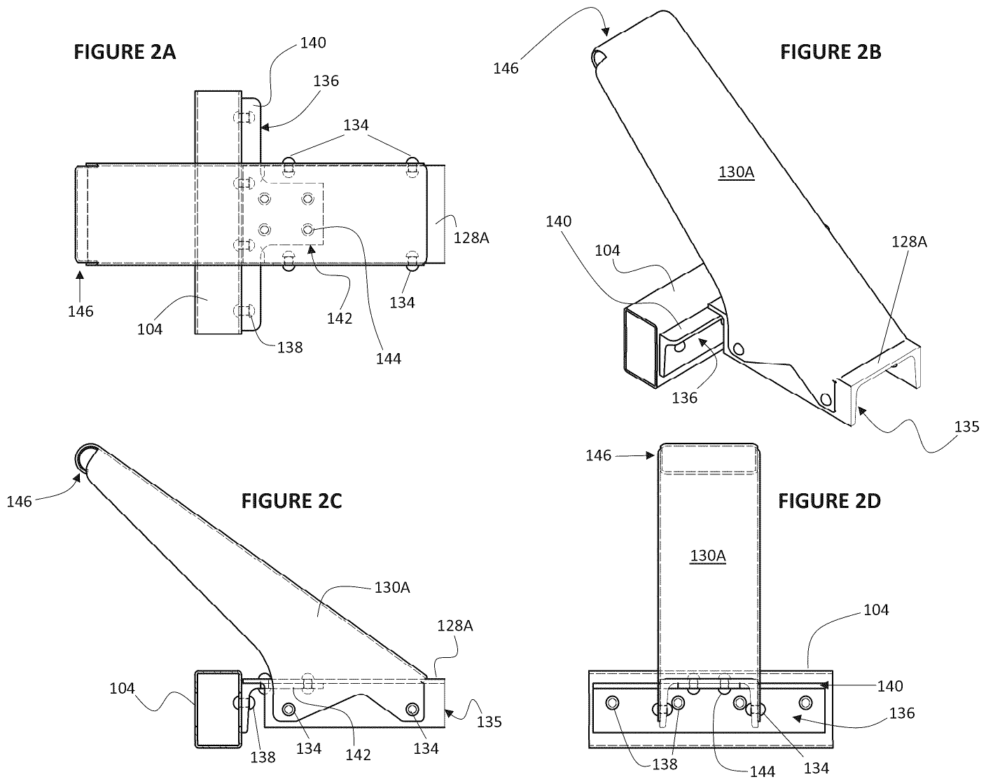

FIGS. 2A-2D show one example way in which the first cradle 124 may be fixed to the first longitudinal member 104. In this example, the upward extending segment 130A is attached to the base 128A via fasteners 134. FIGS. 2B and 2C illustrate how the base 128A may be formed in some examples from part of a laterally-extending member 135 that extends all the way from the first longitudinal member 104 to the second longitudinal member 106.

Notwithstanding, a connection member 136, which in some cases is a one-piece construction cut from a parallel-flanged channel beam, may be attached to the first longitudinal member 104 with fasteners 138. The connection member 136 may have a longitudinal length that is in some instances at least twice the longitudinal length of the first cradle 124. The longitudinal length of the connection member 136 reinforces the first longitudinal member 104 and helps the first longitudinal member 104 withstand bending moments in a horizontal plane, including bending moments in the horizontal plane between longitudinal member 104, 106 and axle beams. The connection member 136 may have a lip 140 with a central protrusion 142 to which the laterally-extending member 135 of the first cradle 124 is fixed with fasteners 144. As shown in FIG. 2A, to give ample overlapping surface area for connection between the laterally-extending member 135 and the connection member 136, the central protrusion 142 of the connection member 136 may have a lateral extent that is at least twice the lateral extent of the first longitudinal member 104.

In still other cases, the cradles may be welded to the longitudinal members and/or connection members. Still further, the cradles may in some cases by welded and/or fastened directly to a top surface of the longitudinal members. FIGS. 2A-2D also show the upward extending segment 130 with a rounded distal end 146. The rounded distal end 146 can help ensure that the first cradle 124 does not damage or lacerate the carry belt, especially when loaded with bulk material. Lastly, it should be understood that the description of certain components, connections, and aspects herein may be equally applicable to other components, connections, and aspects of the present disclosure, even if not explicitly stated elsewhere. As merely one example, the second cradle 126 may be fixed to the second longitudinal member 106 in the same way in which the first cradle 124 is fixed to the first longitudinal member 104.

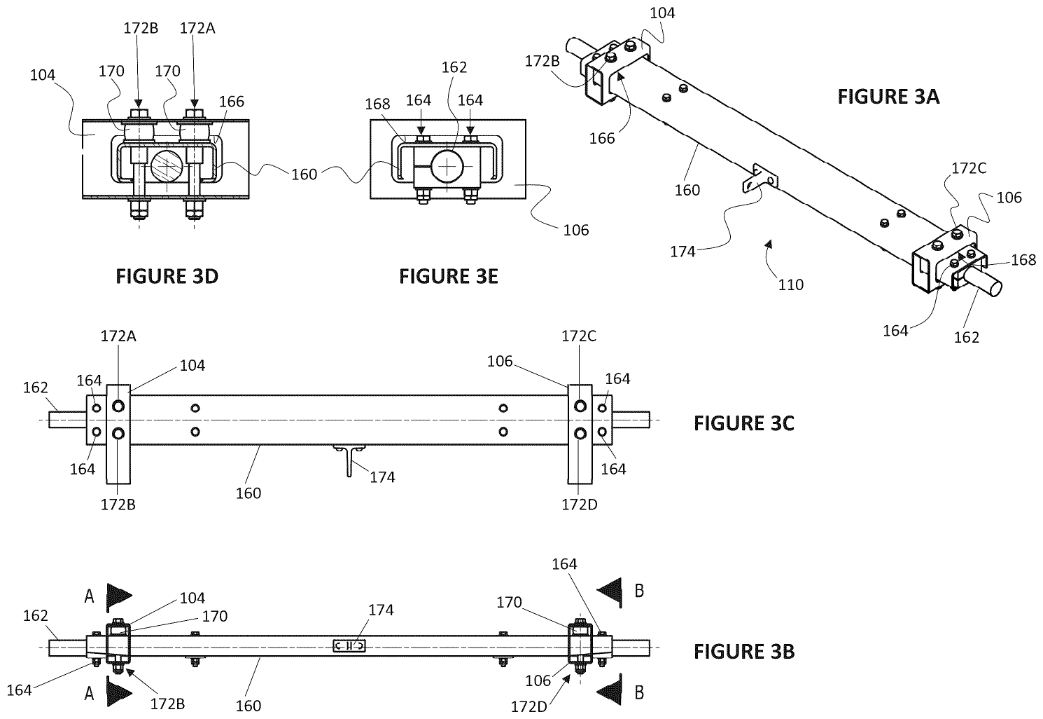

Turning now to FIGS. 3A-3E, the example second crossmember 110 is shown in more detail. The second crossmember 110 may include an axle beam 160 through which an axle 162 extends. The axle 162 may be clamped in the axle beam 160 with the aid of fasteners 164, as shown particularly in FIG. 3E, which corresponds to the section taken across line B-B in FIG. 3B. In this particular example, the axle 162 is a “dead shaft” that does not rotate. Bearings may be disposed in the wheels 112 that allow the wheels 112 to rotate relative to the axle 162.

Yet in other examples, the axles can be configured as “live axles” that rotate with the wheels and with bearings that allow the live axles to rotate relative to the axle beams. FIGS. 3A-3D show the axle beam 160 extending through openings 166, 168 in the first and second longitudinal members 104, 106. The through-axle design balances moments on left and right sides of the carriage 100 so that the longitudinal members 104, 106 experience a fraction of the torsion that they would otherwise with stub axles. To dampen vibrations between the crossmember 110 and the longitudinal members 104, 106 and provide suspension onboard the carriage 100, damping means 170 may be disposed on or at fasteners 172A, 172B, 172C, 172D joining the crossmember 110 and the longitudinal members 104, 106. The damping means 170 may take the form of compression springs or rubber bushings, for example and without limitation. As a result, the axle beam 160 can move at least slightly relative to the longitudinal members 104, 106.

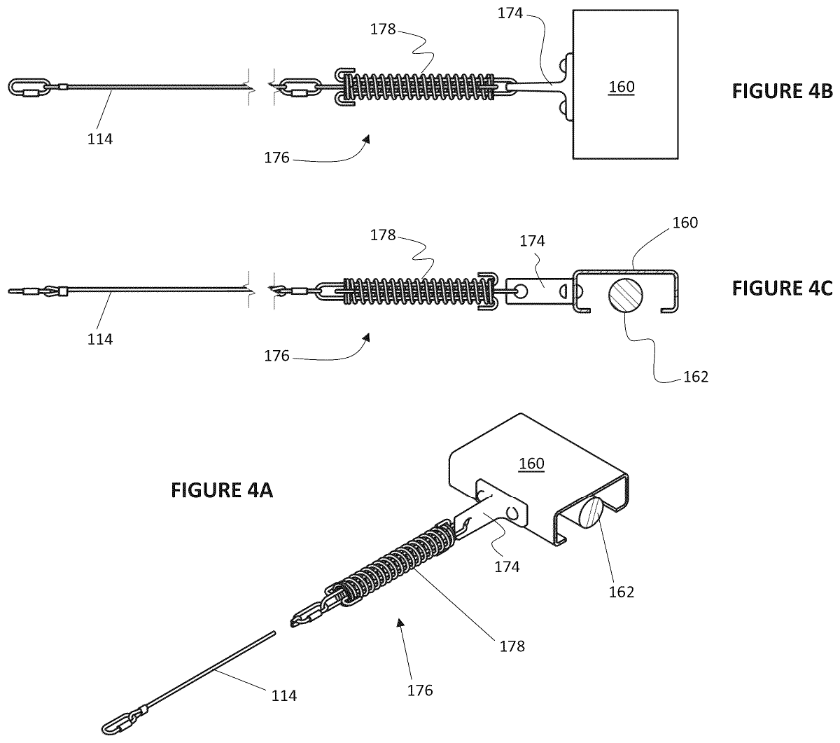

As shown in FIGS. 3A-3D and FIGS. 4A-4C as well, a coupling piece 174 may be fixed to the axle beam 160 and configured for direct or indirect attachment to the cable 114 that primarily spaces the carriages, but tows the carriages through turnaround loops. FIGS. 4A-4C show an example whereby the coupling piece 174 is attached to the cable 114 via a safety spring 176. At least in cases where the cable 114 is used primarily to space the carriages apart from one another, the safety spring 176 may include a compression spring 178 that dampens vibrations and softens the transfer of loads from the cable 114 to the coupling piece 174 and thus the carriage 100. The safety spring 176 may be configured such that even if the compression spring 178 fails, loads will still be transferred from the cable 114 to the coupling piece 174 and vice versa.

It should be understood that each and every carriage in a system need not be connected to the cable 114 via safety springs like the safety spring 176. For example, in some cases the benefits of employing one safety spring per every three to eight carriages may be virtually the same as employing one safety spring per carriage. With respect to a turnaround loop of a rail conveyor system especially, it is advantageous to have at least one safety spring present in the turnaround loop at all points in time.

Furthermore, it should be understood a cable tension in the loop may be provided by means other than a safety spring, including but not limited to arrangements of tension or compression springs, or by selecting the cable itself to have an equivalent or sufficient elasticity.

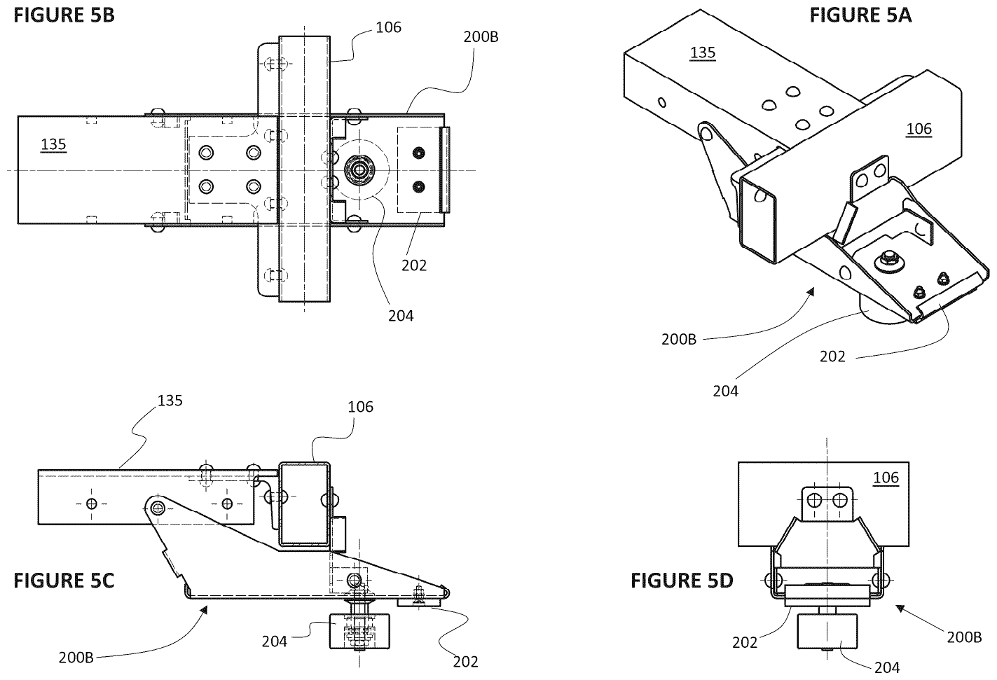

As shown in FIGS. 1B, 1D, and 5A-5D, the example carriage 100 may further include outrigger brackets 200A, 200B, 200C, 200D. The outrigger bracket 200B, shown in more detail in FIGS. 5A-5D, may be fastened or otherwise fixed to both the second longitudinal member 106 and the laterally-extending member 135 of the first cradle 124. In other examples, the outrigger bracket 200B may be formed integrally with/from the laterally-extending member 135. Either way, the outrigger bracket 200B may include a slider pad 202 that is fastened thereto and configured to support the frame 102 of the carriage 100 and allow the frame 102 to slide along a guide rail in the event that a wheel is lost. In FIG. 1B, one can see how each slider pad 202 may be longitudinally aligned with each respective wheel 112. Moreover, in terms of vertical placement of the slider pad 202, a bottom of the slider pad 202 may be disposed between two to five centimeters above a location where the wheel 112 contacts the guide rail.

The outrigger bracket 200B further includes a lateral wheel 204 that is configured, at least through some sections of track, to roll along the guide rail and maintain the lateral position of the carriage 100 relative to the guide rail, particularly as the carriage 100 travels through curves in the path and particularly when used in connection with lateral wheels on the other outrigger brackets 200A, 200C, 200D. The lateral wheels 204 help limit lateral forces on flanged sections of the primary wheels 112 of the carriage 100, especially in tight-radius horizontal curves, thereby reducing friction through such horizontal curves. Alternatively, in other examples the outrigger bracket 200B may include a vertical pad instead of a lateral wheel. Such a vertical pad may be configured to contact the guide rail only when necessary to prevent the carriage 100 from derailing.

The spacing between the lateral wheels 204 and the guide rails may be based on the geometry of the wheels 112 or the trajectory of the section of track through which the carriage 100 is passing. For example, the lateral wheel 204 may be spaced apart from the guide rail such that the lateral wheel 204 only contacts the guide rail after a nearest wheel 112 of the carriage 100 has experienced a certain degree of “flange climb” with the guide rail. In some implementations, the lateral wheel 204 may extend below a bottom of the guide rail so that even after a flanged section of the wheel 112 has lifted clear of the guide rail, the lateral wheel 204 prevents the flanged section of the wheel 112 from running off the guide rail entirely. In addition, to ensure precise dimensional tolerancing between the lateral wheel 204, the nearest wheel 112, and the guide rail, the outrigger bracket 200B may be attached to a mounting point along the same longitudinal member that supports the axle of the nearest wheel 112.

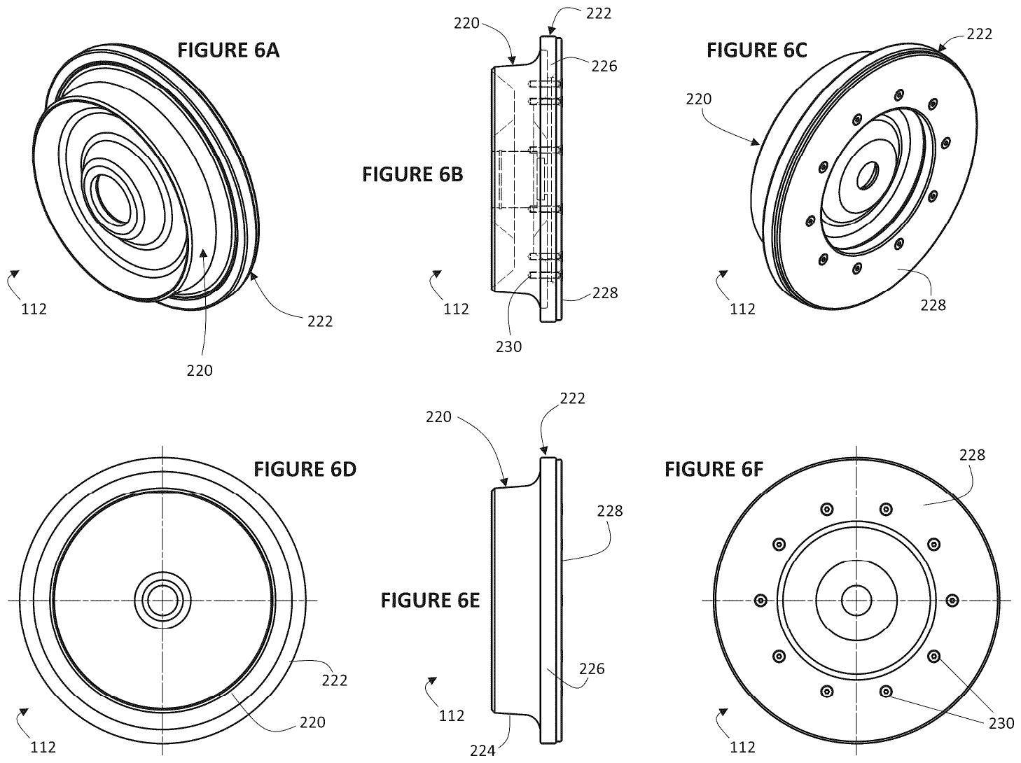

Still another aspect of the present disclosure concerns the load-bearing wheels 112 of the carriage 100. As shown best in FIGS. 6A-6F, each wheel 112 may have a core section 220 and a flanged section 222. The core section 220 may have a conical face 224, which enables the wheels 112 to spin at different rates when the carriage 100 travels through a curve. In some examples, a diameter of the flanged section 222 may be at least 15%, 20%, 25%, 30%, 35%, 40%, 45%, or even 50% greater than a smallest diameter of the conical face 224 of the core section 220. The flanged section 222 of the wheel 112 may include a composite annulus 226 that is sandwiched between the core and a steel backing ring 228. The composite annulus 226 may in some applications be comprised of an ultra-high-molecular-weight polyethylene (UHMWPE).

The composite annulus 226 and the steel backing ring 228 may be secured to the core section 220 by, for example, fasteners 230 that pass through through-holes in the composite annulus 226 and engage into threaded bores 232 in the core section 220. The increased diameter of the flanged section 222 serves to reduce the risk of derailment by “flange-climbing” in two ways. Firstly, the greater diameter requires the wheel 112 to climb a greater distance before the flanged section 222 tops out on the head of the guide rail. Secondly, the larger flange diameter 222 allows for the clearance between an anti-derailing device and its limiting restraint (such as those described elsewhere in this specification) to be taken up before the flanged section 222 can climb to the top of the guide rail. The steel backing ring 228 serves to provide the required strength to the composite annulus 226. The particularly low coefficient of friction of the composite annulus 226 helps eliminate flange climb that can occur when the friction between a steel flanged section and a steel guide rail on a curve causes a wheel to climb up and over the steel guide rail.

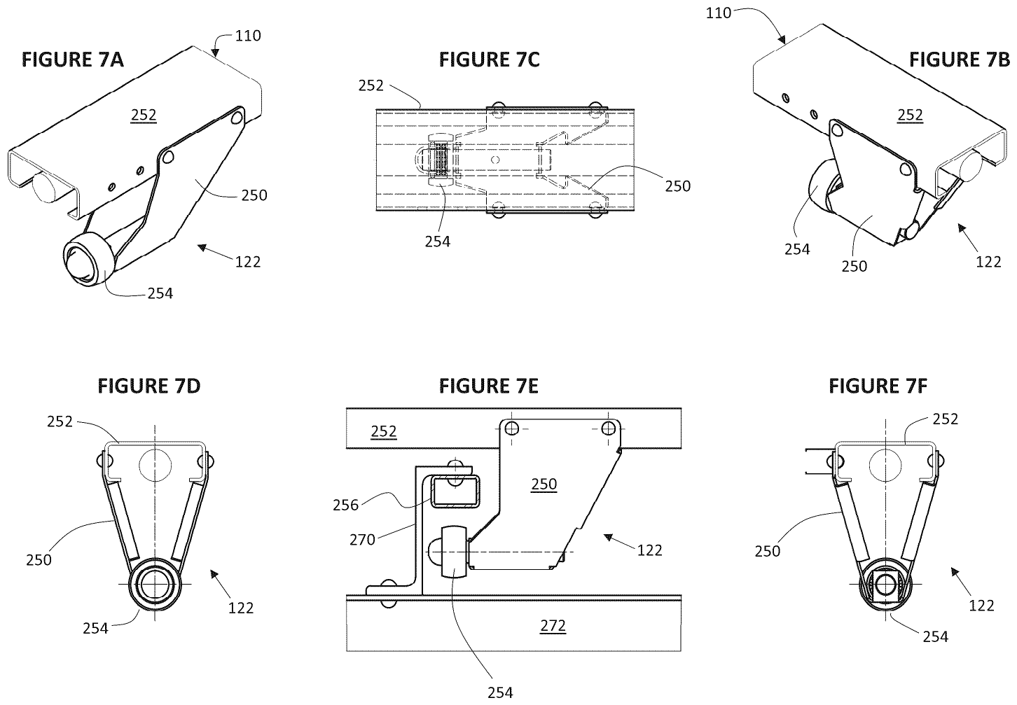

FIGS. 7A-7F show the example anti-derailment device 122 of the carriage 100 in more detail. In this example, the anti-derailment device 122 may include a bracket 250 that is fixed to an axle beam 252 of the second crossmember 110. In other examples, the anti-derailment device 122 could be fixed to the second cradle 126. Or multiple anti-derailment devices could be fixed to the crossmembers and/or the cradles. Nevertheless, a catch-wheel 254 or a slider pad may be attached to the bracket 250 in cantilevered fashion. The cantilevered nature of the connection between the catch-wheel 254 and the bracket 250 may enable the carriage 100 to be more easily removed mid-track if need be.

In cases where the carriage 100 begins to derail or in cases where one or more of the wheels 112 disengages one of two primary guide rails, the catch-wheel 254 may contact a third rail 256 that extends longitudinally along the track between the two primary guide rails. To that end, a gap between the catch-wheel 254 and the third rail 256 may correspond to the extent to which the flanged sections 222 of the wheels 112 protrude from a largest diameter of the core sections 220 of the wheels 112. For instance, the gap between the catch-wheel 254 and the third rail 256 may be 0.7-1.2 times, 1.0-1.5 times, 1.0-2.0 times, 1.5-2.0 times, 1.5-2.5 times, or 2.0-3.0 times the extent to which the flanged sections 222 of the wheels 112 protrude from the largest diameter of the core sections 220 of the wheels 112. In some cases, the gap between the catch-wheel 254 and the third rail 256 may be about 5 mm. In short, the gap may be large enough that the catch-wheel 254 does not engage the third rail 256 due to structural variations, but should be small enough that engagement will occur before a wheel 112 lifts so high as to allow a flange section 222 to climb over a guide rail. Likewise, the gap should be small enough to accommodate expected reduction in guide rail height due to wear.

By contrast, at some locations (e.g., a horizontal turnaround loop that has inward camber) it may be advantageous for the catch-wheel 254 to always engage the third rail 256. At these locations, the gap between the catch-wheel 254 and the third rail 256 may be decreased or eliminated by adjusting a height of the third rail 256 relative to the guide rails.

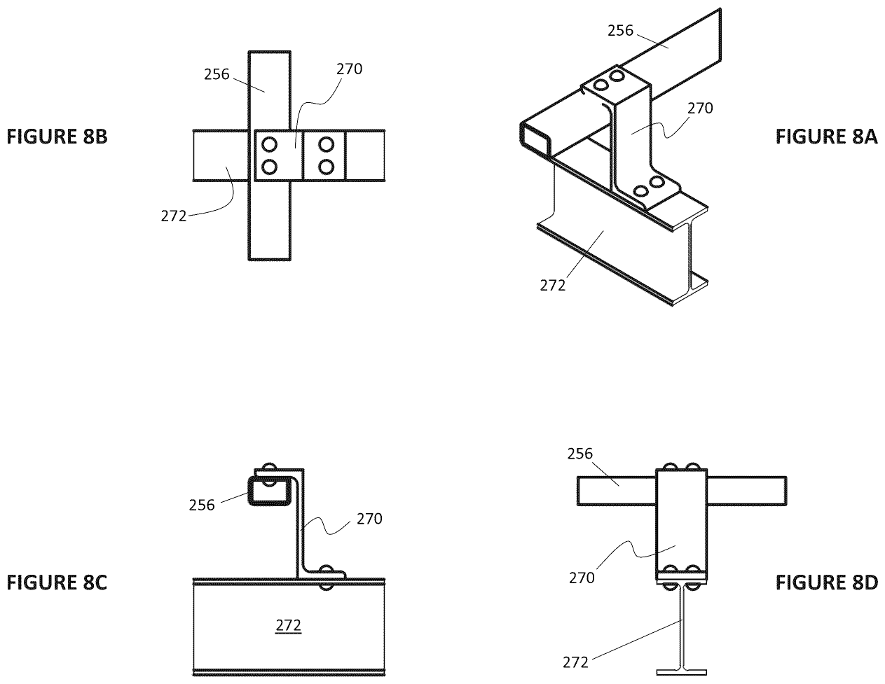

FIG. 7E illustrates one example way in which the third rail 256 may be supported. In this example, the third rail 256 is fixed to a bracket 270 that is in turn fixed to a lateral-extending member 272 of a frame that supports the two primary guide rails. FIGS. 8A-8D show still further perspectives of this form of support of the third rail 256.

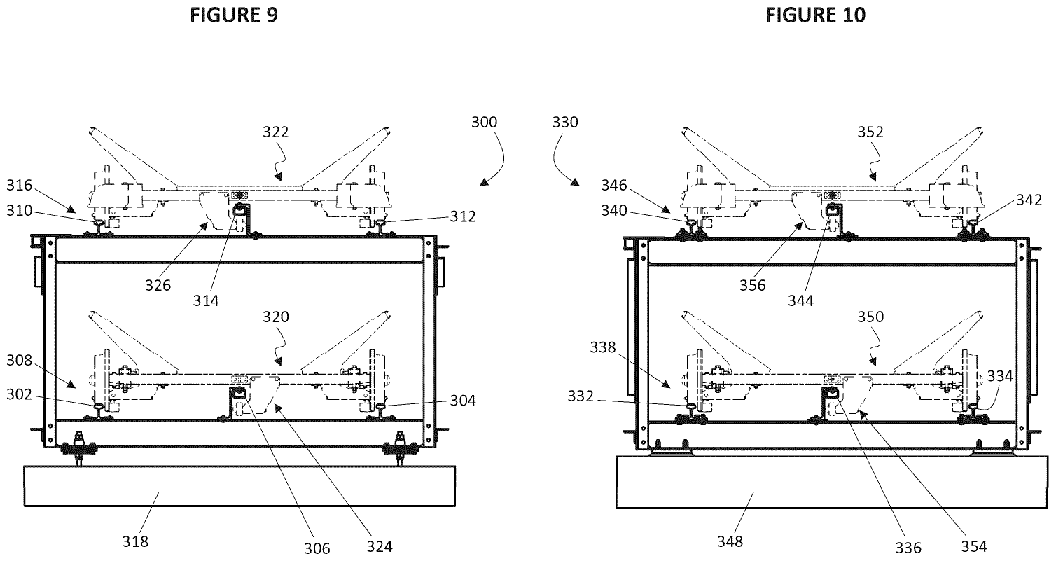

FIG. 9 shows an example slidable frame module 300 with two primary guide rails 302, 304 and a third rail 306 on a lower, return run 308 and with two primary guide rails 310, 312 and a third rail 314 on an upper, carry run 316. The frame module 300 in FIG. 9 is slidable because, as will be described in greater detail further below, the frame module 300 is slidably coupled to one or more footings 318, which enables the frame module 300 to move modestly in the longitudinal direction to accommodate the longitudinal expansion and contraction of the guide rails. Two carriages 320, 322 with anti-derailment devices 324, 326 are also shown for context.

By contrast, FIG. 10 shows an example expansion frame module 330 with two primary guide rails 332, 334 and a third rail 336 on a lower, return run 338 and with two primary guide rails 340, 342 and a third rail 344 on an upper, carry run 346. Even though the frame module 330 is securely fixed to one or more footings 348, the frame module 330 in FIG. 10 is said to be an expansion frame module because, as will be described in greater detail further below, the frame module 330 includes expansion joints that allow the rails to expand and contract longitudinally. Two carriages 350, 352 with anti-derailment devices 354, 356 are also shown for context.

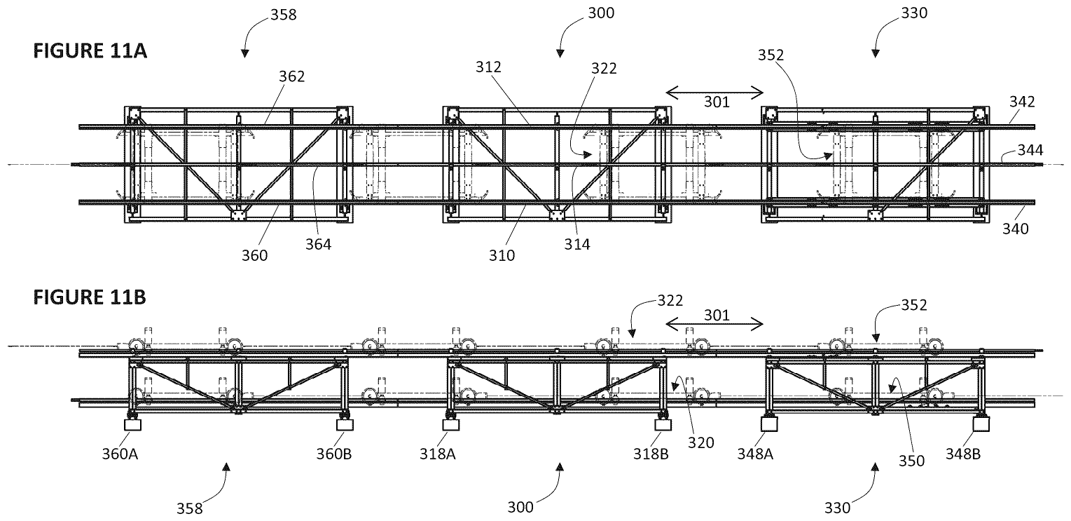

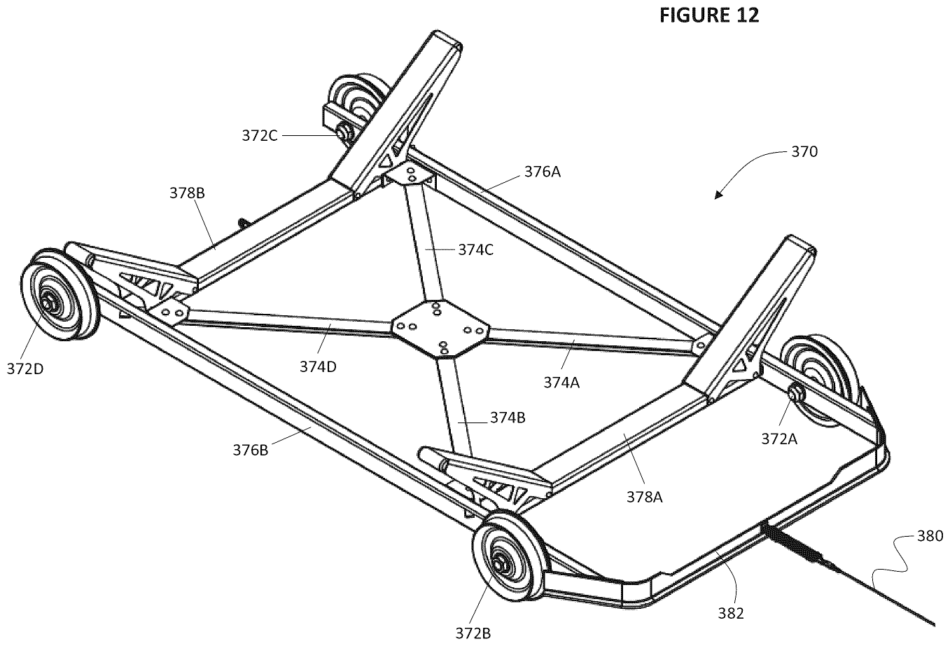

FIGS. 11A and 11B show one example arrangement where the expansion frame module 330 is adjacent to the slidable frame module 300 and a second slidable frame module 358. The second slidable frame module 358 may likewise be supported on footings 360A, 360B, for example. The two primary guide rails 340, 342 of the upper, carry run 346 of the expansion frame module 330 join with the two primary guide rails 310, 312 of the upper, carry run 316 of the slidable frame module 300, which in turn join with two primary guide rails 360, 362 of an upper, carry run of the second slidable frame module 358. Meanwhile, the third rail 344 of the upper, carry run 346 of the expansion frame module 330 joins with the third rail 314 of the upper, carry run 316 of the slidable frame module 300, which in turn joins a third rail 364 of the upper, carry run of the second slidable frame module 358.

It should be understood that the primary guide rails and the third rail may similarly extend across and be supported by the frame modules along the lower, return run too. The interconnection of the frame modules and different types of frame modules will be explained further, below. One of the primary purposes of FIGS. 11A and 11B is to demonstrate one example way in which a third rail and guide rails may extend from one frame module to the next along the path of a conveyor rail system. And although the terms “join” and “joins” are used figuratively in this paragraph to relate constituent reference characters from prior figures, one having ordinary skill in the art will recognize that the rails, at least across and between some frame modules, may be continuous without joints, seams, or the like.

Another important feature illustrated in FIG. 11A and 11B is that the frame modules (for example 358, 300, 330) are supported on the ground as independent structures configured to continuously support at least the upper the guide rails (340, 342). FIGS. 11A and 11B show an unsupported section (301) of guide rails (340, 342) interposed between adjacent frame modules (for example 358, 300, 330) where the guide rails (340, 342) are not supported or constrained by any stiff structure. This unsupported section (301) serves to allow the rails to elastically curve in a vertical plane to accommodate either the terrain over which the rail conveyor is constructed, or else differential settlement that might arise over time between adjacent modules.

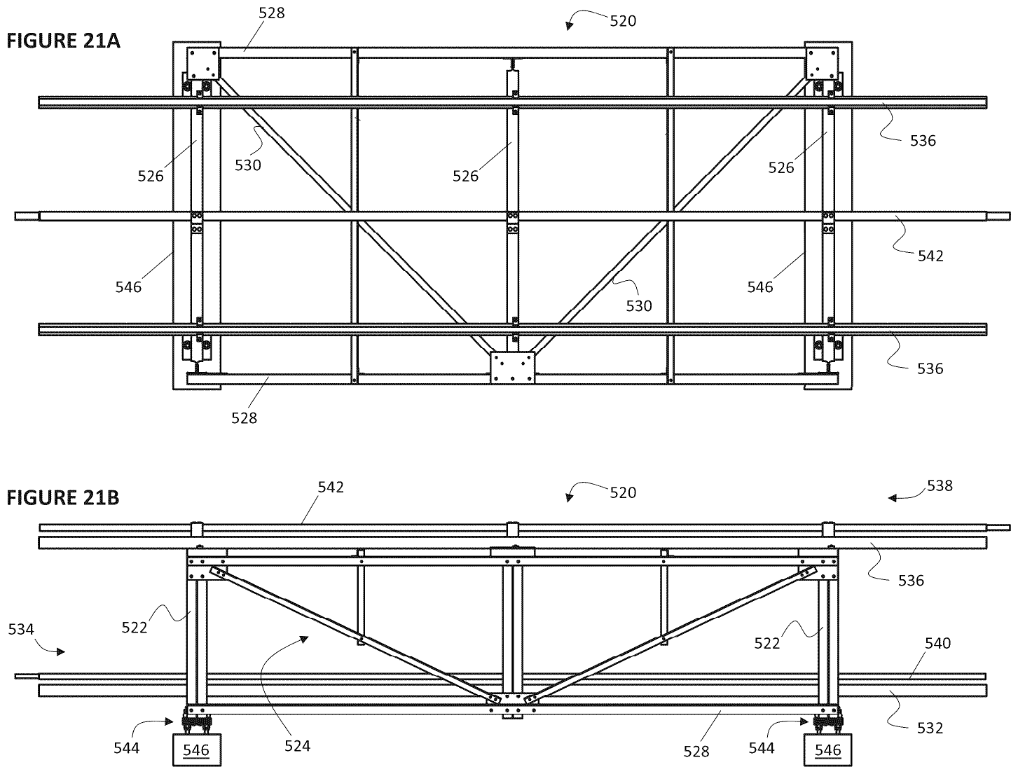

The length of the unsupported section (301) will depend on the required amount of elastic vertical curvature in an area of the rail conveyor. In some cases, the unsupported section (301) length may be similar to a distance between the guide rail support beams (526) illustrated in FIG. 21A. In other cases, the unsupported section (301) length may be about 30 or more times the section height of a guide rail (340, 342). In yet other cases, the unsupported section (301) length may be as little as 5 or 10 times the section height of a guide rail (340, 342).

FIG. 12 shows another example carriage 370 that differs from the example carriage 100 in at least the following ways. The carriage 370 includes stub axles 372A, 372B, 372C, 372D, as opposed to through-axles. The carriage 370 includes cross-braces 374A, 374B, 374C, 374D that are transverse to longitudinal members 376A, 376B and crossmembers 378A, 378B of the carriage 370. And the carriage 370 is coupled to a cable 380 at a bumper 382 that extends from the first longitudinal member 376A to the second longitudinal member 376B.

Although the carriage 370 is shown without the example anti-derailment device shown on the carriage 100 in the preceding figures, it should be understood that in some examples the carriage 370 may be modified to include such an anti-derailment device. Needless to say, the carriages depicted and described herein are exemplary. As one example, still other carriages envisioned by the present disclosure may include wheels that ride along a bottom of each guide rail, further reducing the risks of carriage lift-off and/or carriage derailment. As another example, carriages could be supported by and travel along a form of monorail, such as that described in U.S. Pat. No. 8,887,900, which is entitled “Rail Conveyor System,” which was filed Jan. 22, 2013, and which is incorporated herein by reference in its entirety.

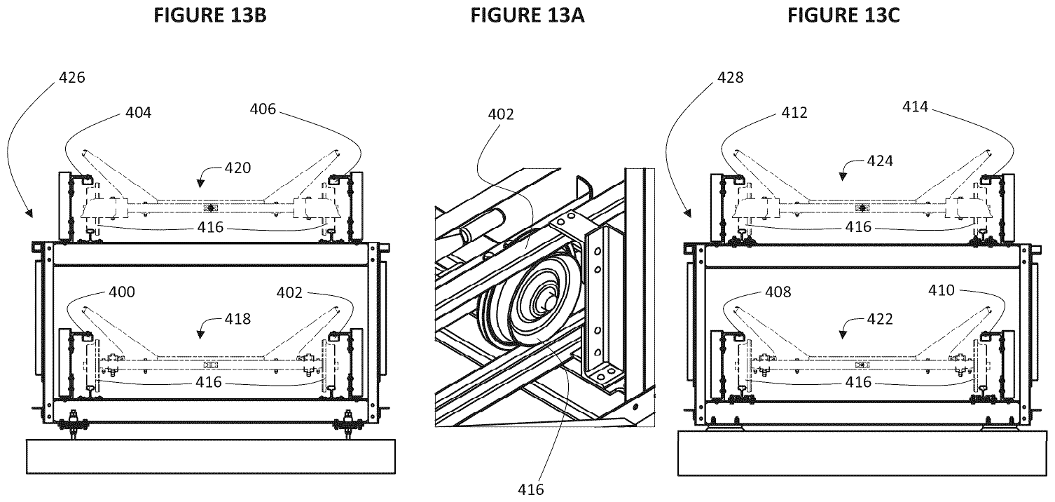

The present disclosure concerns other forms of anti-derailment features as well. For instance, FIGS. 13A-13C illustrate example anti-derailment guides 400, 402, 404, 406, 408, 410, 412, 414 that are positioned just above wheels 416 of carriages 418, 420, 422, 424 on a slidable frame module 426 (FIG. 13B) and on an expansion frame module 428 (FIG. 13C) and extend either along select longitudinal segments of the track or along an entirety of a longitudinal extent of the track. In cases where the anti-derailment guides are disposed only along select longitudinal segments of the track, depending on the path and geometry of the track it may be effective to utilize an anti-derailment guide only on one lateral side of the track. In some examples, a gap between a core section of each wheel 416 and the anti-derailment guides 400, 402, 404, 406, 408, 410, 412, 414 is less than a height of a flange section of each wheel 416.

In other words, a bottom of each of the anti-derailment guides 400, 402, 404, 406, 408, 410, 412, 414 may be, with respect to a height of each carriage 418, 420, 422, 424, vertically lower than an uppermost portion of the flange section of each wheel 416. Indeed, in some applications the gap between the core section of each wheel 416 and the anti-derailment guides 400, 402, 404, 406, 408, 410, 412, 414 may vary along the longitudinal length of the track. For example, in longitudinal sections of the track where the wheels 416 may be prone to lifting off primary guide rails, such as in a turnaround loop where the carriage is running vertically to the ground or in a pipe-belt version where in a tight concave curve a belt clamped to a carriage may want to lift off, the gap between the core section of each wheel 416 and the anti-derailment guides 400, 402, 404, 406, 408, 410, 412, 414 may be reduced or even eliminated.

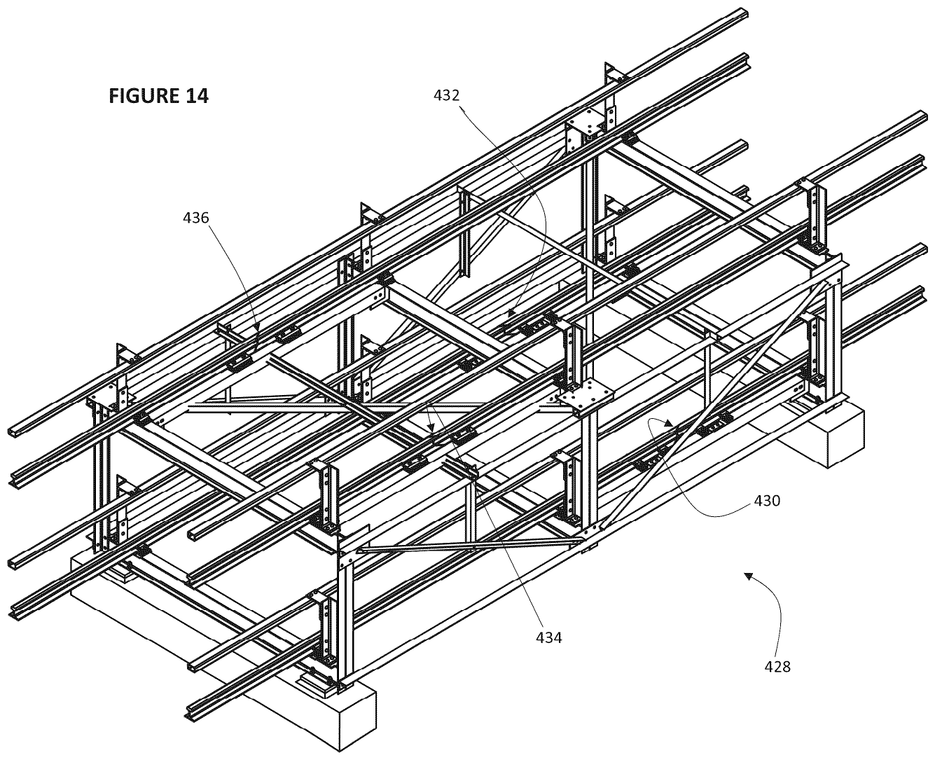

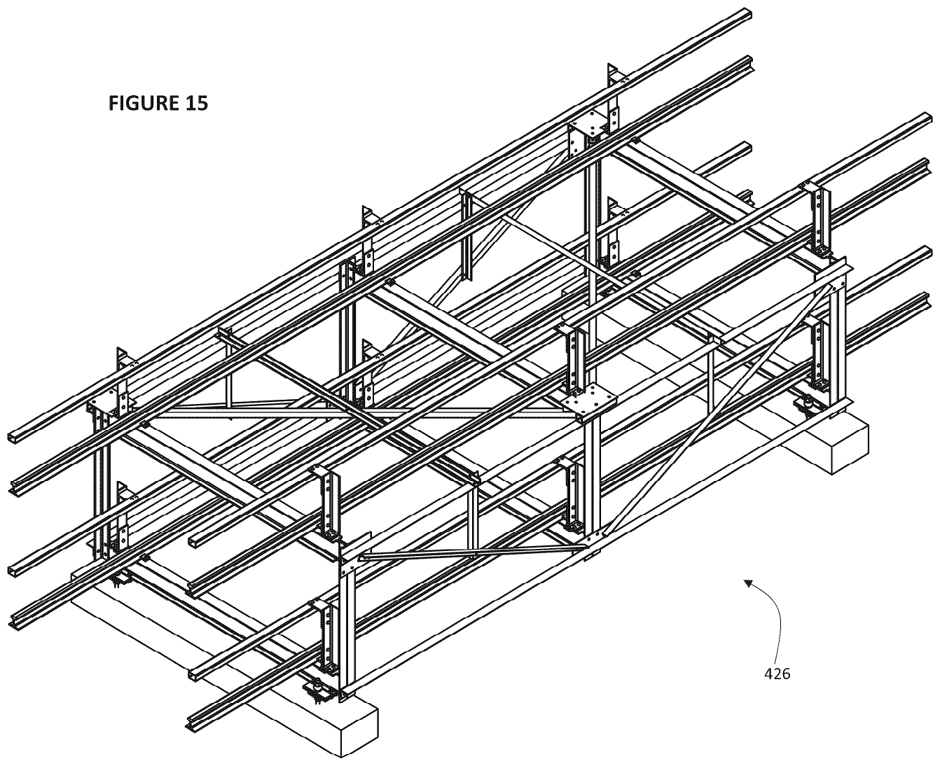

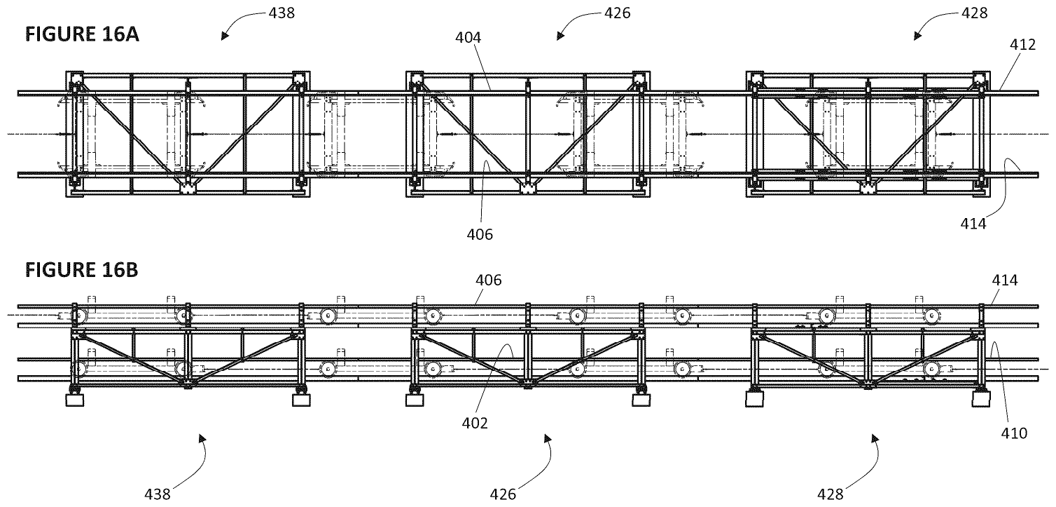

FIG. 14 shows a perspective view of the example expansion frame module 428 shown in FIG. 13C. FIG. 14 illustrates four expansion joints 430, 432, 434, 436 that allow the guide rails to expand and contract longitudinally. FIG. 15, on the other hand, shows a perspective view of the example slidable frame module 426 shown in FIG. 13B. FIGS. 16A (top view) and 16B (side view) show how the expansion frame module 428 may be positioned adjacent the slidable frame module 426 and a second slidable frame module 438. In particular, FIG. 16B illustrates how the anti-derailment guides 402, 404, 406, 410, 412, 414 may extend from one frame module to the next and how the anti-derailment guides 402, 404, 406, 410, 412, 414 may be positioned above the wheels 416 for at least a section along a longitudinal extent of track.

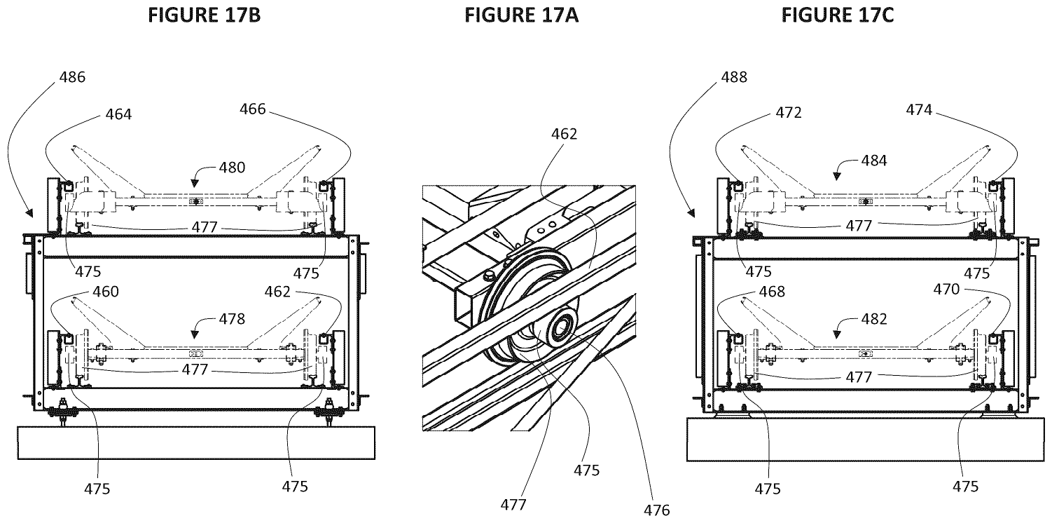

FIGS. 17A-17C show still further example anti-derailment guides 460, 462, 464, 466, 468, 470, 472, 474 that are positioned just above guide wheels 475 on ends of axles 476 that protrude from wheels 477 of carriages 478, 480, 482, 484 on an slidable frame module 486 (FIG. 17B) and on an expansion frame module 488 (FIG. 17C) and extend either along select longitudinal segments of the track or along an entirety of a longitudinal extent of the track. The guide wheels 475 may be adjacent to the wheels 477. In cases, where the axles 476 are “dead axles” and do not rotate with the wheels 477, bearings may be disposed between the axles 476 and the guide wheels 475 to permit the guide wheels 475 to rotate. If the axles 476 are “live” and rotate with the wheels 477, then no such bearings may be necessary. In still other examples, the anti-derailment guides 460, 462, 464, 466, 468, 470, 472, 474 may be configured to selectively engage with protruding portions of the axles directly.

In cases where the anti-derailment guides 460, 462, 464, 466, 468, 470, 472, 474 are disposed only along select longitudinal segments of the track, depending on the trajectory and geometry of the track it may be effective to utilize an anti-derailment guide only on one lateral side of the track. In some implementations, a gap between the guide wheels 475 and the anti-derailment guides 460, 462, 464, 466, 468, 470, 472, 474 may vary along the longitudinal length of the track. For example, in longitudinal sections of the track where carriages are prone to lifting off primary guide rails, such as in a turnaround loop where the carriage is running vertically to the ground or in a pipe-belt version where in a tight concave curve a belt clamped to a carriage may want to lift off, the gap between the guide wheels 475 and the anti-derailment guides 460, 462, 464, 466, 468, 470, 472, 474 may be reduced or even eliminated.

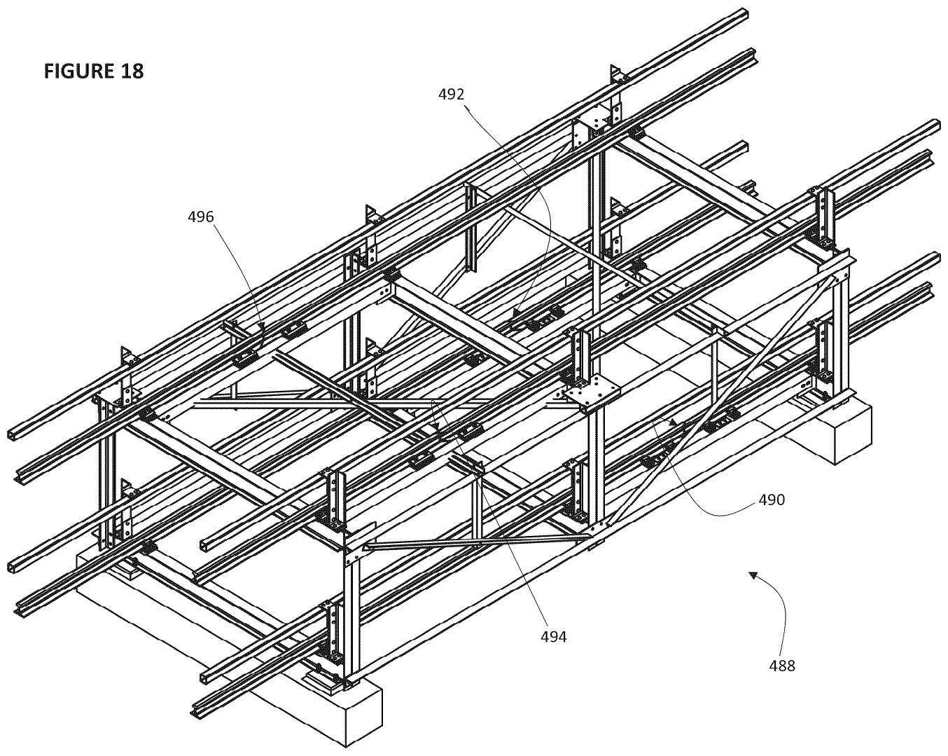

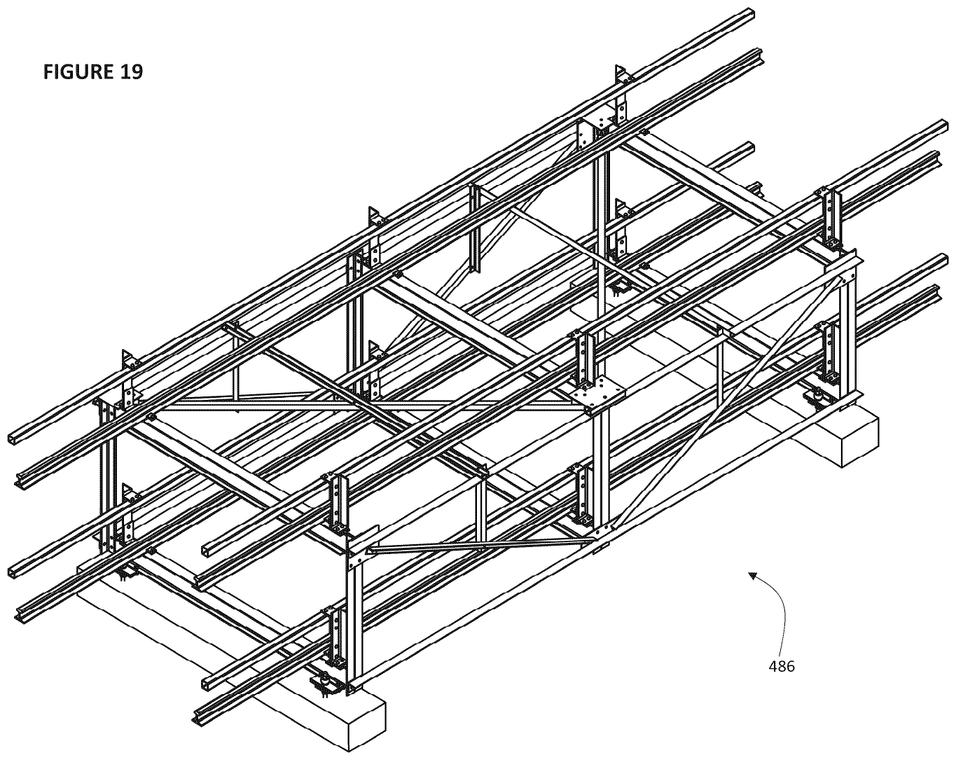

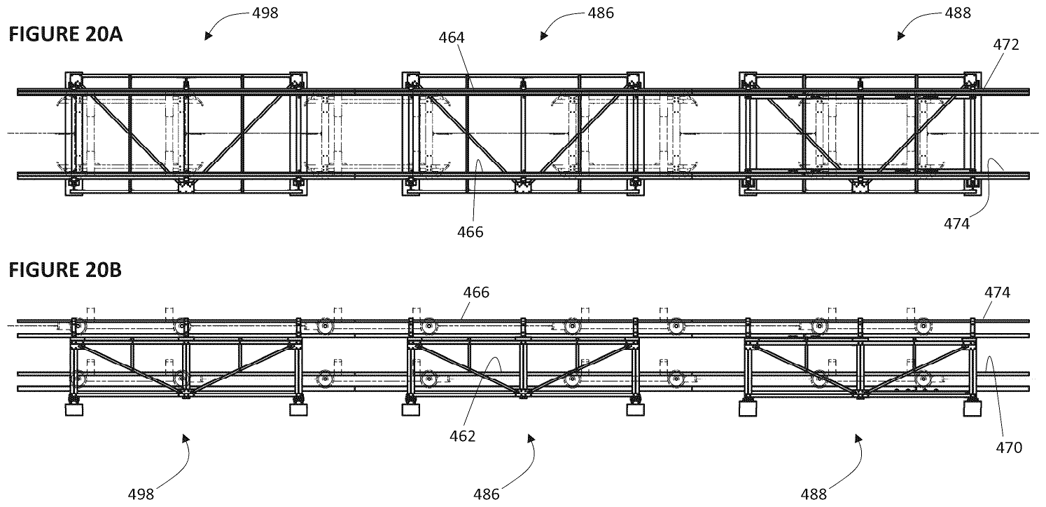

FIG. 18 shows a perspective view of the example expansion frame module 488 shown in FIG. 17C. FIG. 18 illustrates four expansion joints 490, 492, 494, 496 that allow the guide rails to expand and contract longitudinally. FIG. 19, on the other hand, shows a perspective view of the example slidable frame module 486 shown in FIG. 17B. FIGS. 20A (top view) and 20B (side view) show how the expansion frame module 488 may be positioned adjacent the slidable frame module 486 and a second slidable frame module 498. In particular, FIG. 20B illustrates how the anti-derailment guides 462, 464, 466, 470, 472, 474 may extend from one frame module to the next and how the anti-derailment guides 462, 464, 466, 470, 472, 474 may be positioned above the guide wheels 475 for at least a section along a longitudinal extent of track.

FIGS. 21A and 21B show another example slidable frame module 520 in top view (FIG. 21A) and side view (FIG. 21B). The slidable frame module 520 may generally include vertical members 522, truss-like structures 524, lateral members 526, longitudinal members 528, and transverse members 530. On the slidable frame module 520 and on the other frame modules disclosed herein, at least some of the vertical members 522 and the lateral members 526 may be horizontally or vertically adjustable (e.g., by way of slotted connections) to accommodate vertical or horizontal curvature of the guide rails as need be. Those having ordinary skill in the art will appreciate that certain portions of the frame module 520 (e.g., the truss-like structures 524) may be preassembled and need not be assembled onsite.

A lower portion of the slidable frame module 520 may support primary guide rails 532 that form a return run 534. An upper portion of the slidable frame module 520 may support primary guide rails 536 that form a carry run 538. The example slidable frame module 520 shown here also includes third rails 540, 542 on the conveying and return runs 534, 538 that are configured to cooperate with anti-derailment devices of the carriages. Further, slidable connections 544 may slidably attach the slidable frame module 520 to footers 546 that are secured to, planted in, and/or staked to the ground. In many respects, the slidable frame module 520 in FIGS. 21A and 21B is similar to the slidable frame module 486 shown in the perspective view of FIG. 19, except that the slidable frame module 520 includes the third rails 540, 542 instead of anti-derailment guides that extend proximate carriage axles/wheels.

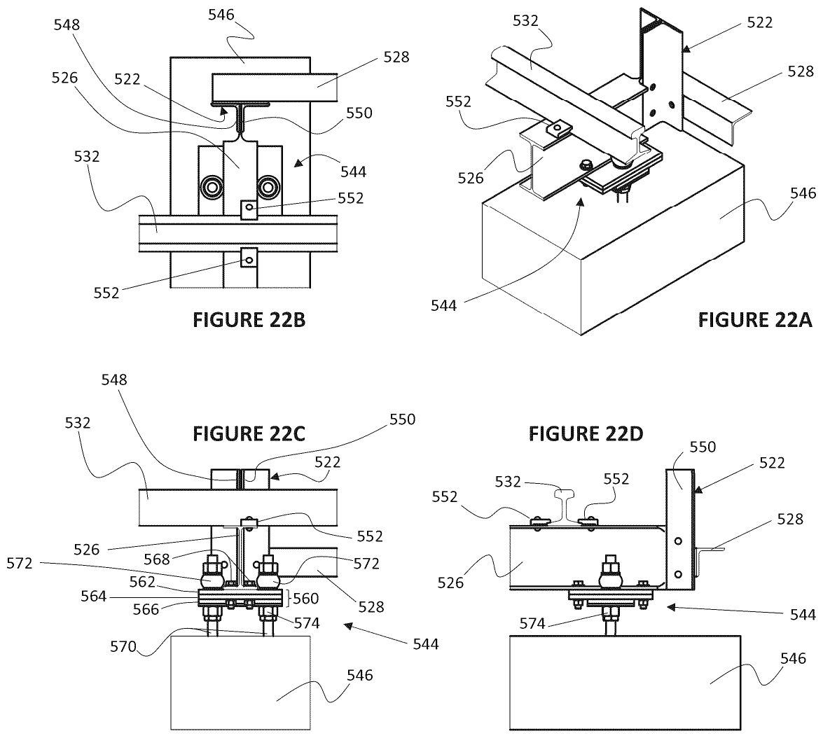

One example of the slidable connection 544 is shown in FIGS. 22A-22D. Here the guide rail 532 is supported by one of the lateral members 526 that has a tongue that is sandwiched between and fastened to two planar faces 548, 550 of one of the vertical members 522. Alternatively, the tongue of the lateral member 526 could fastened alongside one of the planar faces 548, 550 of the vertical member 522. The tongue of the lateral member 526 may in one example be formed by removing portions of an I-beam that forms the lateral member 526.

In one example, the guide rail 532 may be fastened to the lateral member 526 with clips 552, and the lateral member 526 may be attached to the footing 546 via the slidable connection 544. More specifically, in some examples the lateral member 526 may be fastened to plates 560 of the slidable connection 544. In the example shown in FIGS. 22A-22D, the plates 560 include an upper plate 562, a middle plate 564, and a lower plate 566. The lateral member 526 is shown in FIG. 22C and FIG. 22D to be coupled to the upper plate 562 and the middle plate 564 via fasteners 568. Conversely, anchor bolts 570 that are fixed in the footing 546 extend through all three plates 562, 564, 566.

The fasteners 568 and the anchor bolts 570 may extend through slotted apertures in two or more of the plates 562, 564, 566, which slotted apertures are elongated in the longitudinal direction. Further, the plates 562, 564, 566 may have different material compositions to minimize friction between the plates 562, 564, 566. For instance, the upper and lower plates 562, 566 may be comprised of metal, whereas the middle plate 564 may be comprised of plastic. Still further, the anchor bolts 570 may be secured to the plates 562, 564, 566 with bushings 572 that limit the amount of compressive force that can be exerted on the plates 562, 564, 566. Hence the bushings 572 also help minimize friction between the plates 562, 564, 566. Consequently, the plates 562, 564, 566 can slide longitudinally relative to one another, thereby permitting the lateral member 526-and thus the slidable frame module 520-to move longitudinally with the guide rail 532 relative to the stationary footing 546 as the guide rail 532 expands and contracts in the longitudinal direction.

Of course, the slidable connection 544 shown in the preceding figures is purely exemplary. Other slidable connections may utilize pendulums, hinges, wheels, or rollers, for example and without limitation. Moreover, the bottom nuts 574 disposed on the fasteners 570 may be used to set the height of the plates 560 and thus the lateral member 526 relative to the footing 546. Alternatively, other height-setting means such as jacks or adjustable brackets, for example, may also be used. In some instances, a method of assembling the frame of a rail conveyor system may involve placing footings (or “sleepers”) on a prepared bed, adjusting a height of the height-setting means (e.g., the nuts 574) attached to the footings, and attaching the frame modules to the height-setting means.

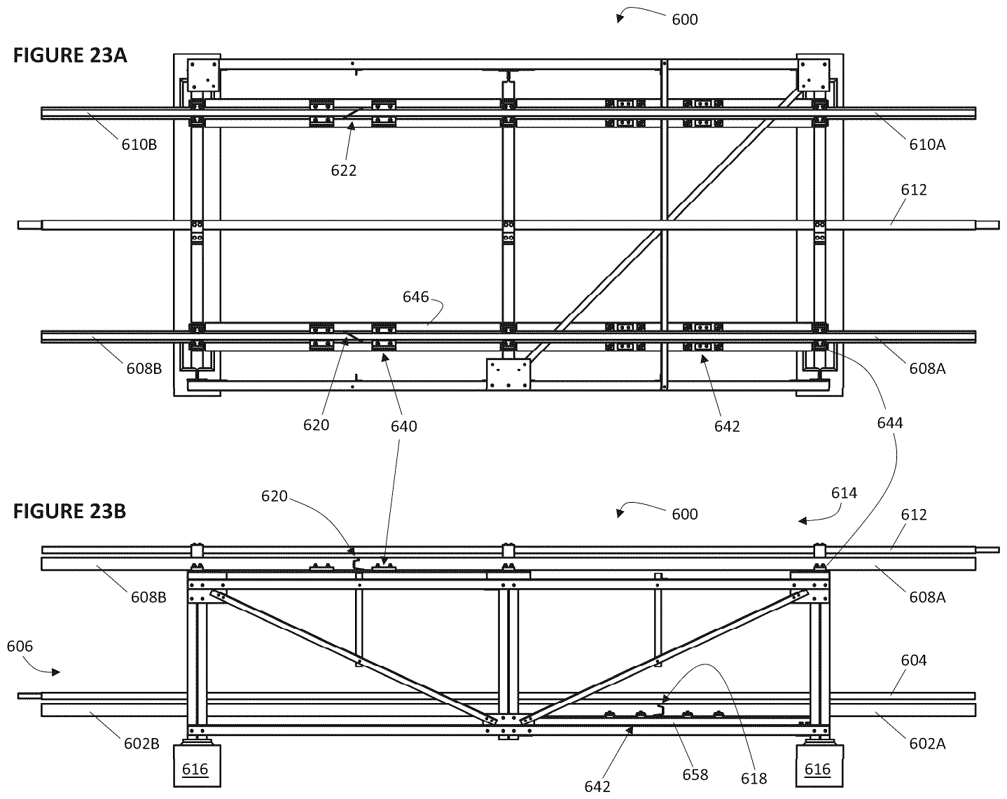

FIGS. 23A and 23B show an example expansion frame module 600 that includes two primary guide rails 602 (only one of which is visible) and a third rail 604 on a lower, return run 606. The expansion frame module 600 also includes two primary guide rails 608, 610 and a third rail 612 on an upper, carry run 614. Even though the frame module 600 is securely fixed to one or more footings 616, the frame module 600 is referred to as an expansion frame module because the frame module 600 includes expansion joints 618, 620, 622 (only three of which are visible) that allow the guide rails to expand and contract longitudinally. In some instances, the expansion joints may comprise gaps between longitudinally-spaced-apart ends of each guide rail. Due to the expansion joint 618, for instance, the portion 602A of the guide rail 602 can expand and contract towards and away from the portion 602B of the guide rail 602 on the other longitudinal side of the expansion joint 618, and vice versa. The same goes for the portions 608A, 608B of the guide rail 608, as well as the portions 610A, 610B of the guide rail 610.

As the guide rails 602, 608, 610 expand and contract, the guide rails 602, 608, 610 need to be able to move longitudinally relative to the expansion frame module 600. The present disclosure contemplates a variety of means for slidably attaching the guide rails to expansion frame modules. FIGS. 23A and 23B show at least three different means for slidably attaching the guide rails 602, 608, 610 to the expansion frame module 600, including a first clip 640, a second clip 642, and a third clip 644. A fourth type of clip, which is not visible in FIGS. 23A and 23B will also be described below.

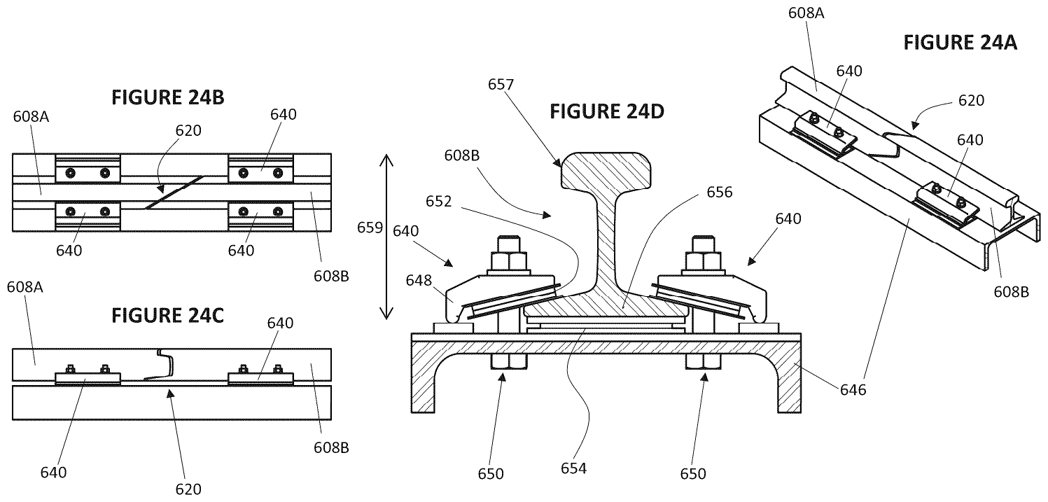

FIGS. 24A-24D show different perspectives of the first clip (or clips) 640, which may be used to longitudinally-slidably secure the guide rails 608A, 608B to a lateral member 646 of the expansion frame module 600. The first clip 640 may include a clamp body 648, fasteners 650, an upper sliding member 652, and a base sliding member 654 that cooperate with another first clip 640 to slidably retain a base 656 of the guide rail 608B on the lateral member 646. The upper sliding member 652 and the base sliding member 654 may be comprised of a composite material, such as thermoplastic, for example, to reduce friction with the base 656 of the guide rail 608B, which in many cases is metallic.

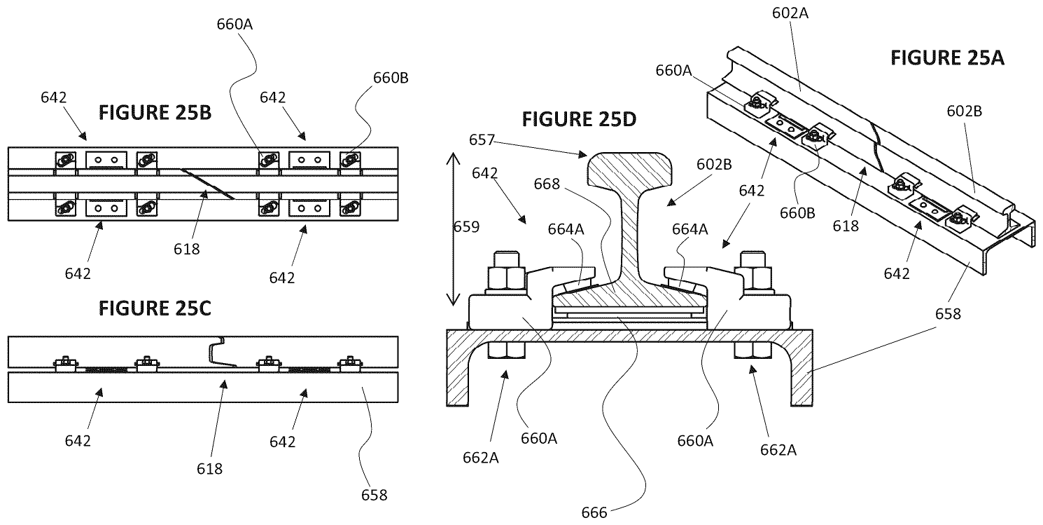

FIGS. 25A-25D show various perspectives of the second clip (or clips) 642, which may be used to longitudinally-slidably secure the guide rails 602A, 602B to a lateral member 658 of the expansion frame module 600. The second clip 642 may include clamp bodies 660A, 660B; fasteners 662A, 662B; upper sliding members 664A, 664B; and a base sliding member 666 that cooperates with another second clip 642 to slidably retain a base 668 of the guide rail 602B on the lateral member 658. Unlike the first clip 640, however, the base sliding member 666 of the second clip 642 is disposed longitudinally between the two clamp bodies 660A, 660B. Moreover, the upper sliding member 664 and the base sliding member 666 may be comprised of a composite material, such as thermoplastic, for example, to reduce friction with the metallic base 668 of the guide rail 602B.

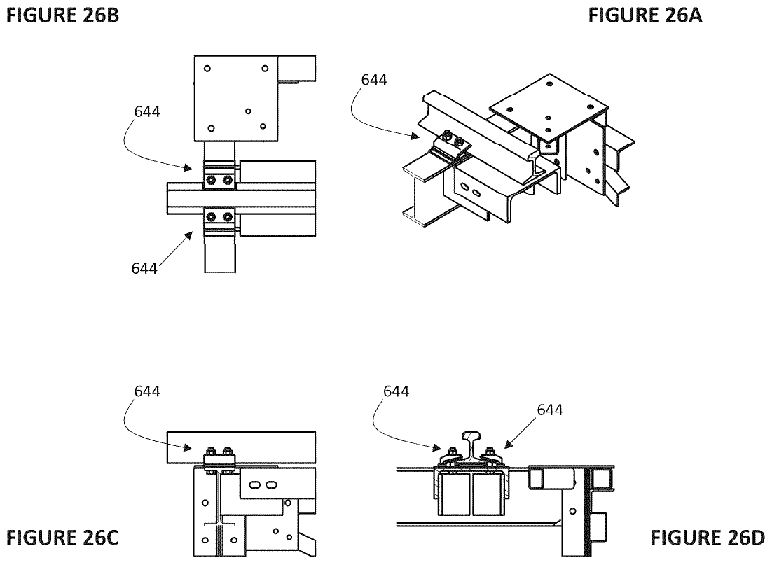

As shown in FIGS. 26A-26D, the third clip 644 is similar to the first clip 610, but may be more compact and can be utilized to support guide rails where the guide rails traverse lateral members and where there is a greater joint stack-up.

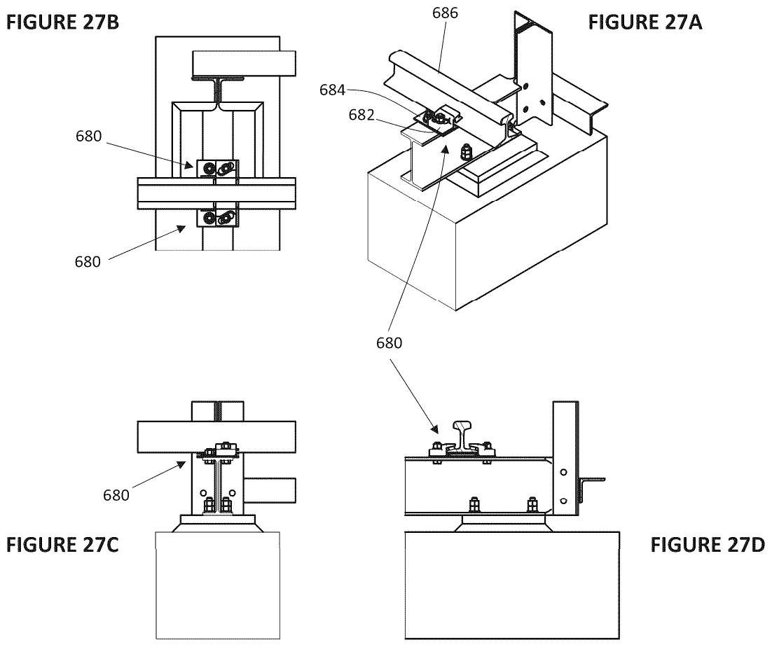

The fourth clip 680 is shown by way of example in FIGS. 27A-27D. The fourth clip 680 may be at least similar to some of the preceding clips. However, the fourth clip 608 involves a clamp body 682 that is disposed on approximately half of a base sliding member 684 that rests underneath a guide rail 686.

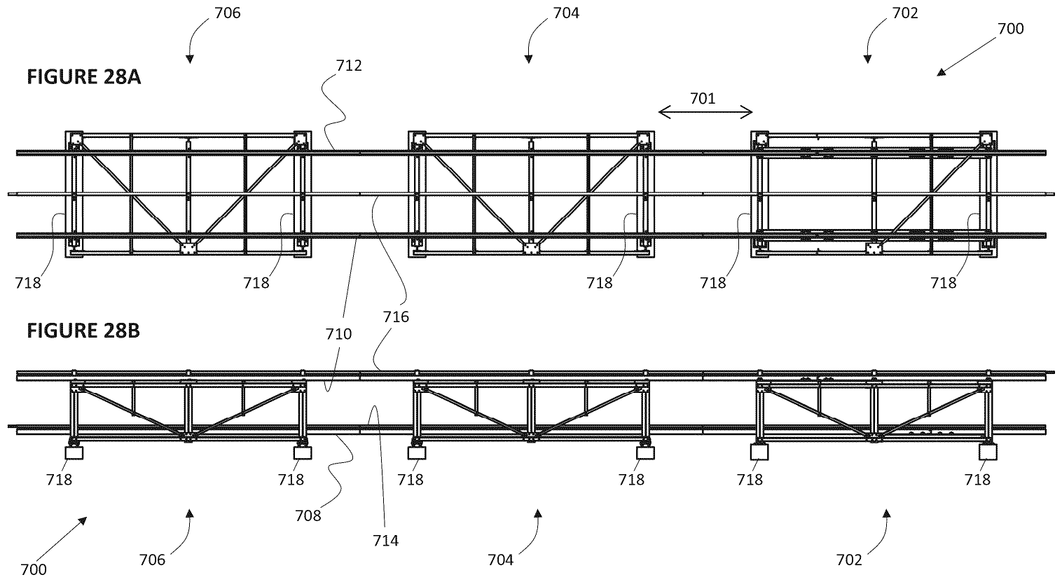

With respect to the spacing and sequencing of frame modules along a longitudinal extent of a track, FIGS. 28A and 28B show part of an example rail conveyor system 700 with an expansion frame module 702 disposed next to two slidable frame modules 704, 706. The expansion frame module 702 and the slidable frame modules 704, 706 are discrete and spaced apart from one another and interconnected only via guide rails 708, 710, 712 (only three of which are visible) and third rails 714, 716.

In some examples, a longitudinal space between each of the frame modules 702, 704, 706 may be greater than 20%, 25%, 33%, 40%, 45%, 50%, 55%, or 60% of a longitudinal extent of one of the frame modules 702, 704, 706. By spacing the frame modules 702, 704, 706 longitudinally, the guide rails 708, 710, 712 and, where employed, the utilized third rails 714, 716 may flex or deform to account for subsidence or washout around footings 718 of the frame modules 702, 704, 706 as at least one of the frame modules 702, 704, 706 settles. In conventional rail systems, subsidence around footings of a longitudinally-continuous frame structure can lead to certain portions of the frame experiencing disproportionately-high loads that in some cases result in failure (e.g., via buckling). Even short of failure, a local change of frame support height may induce a sharp change of slope or discontinuity along the guide rails.

With further regard to the sequencing of frame modules, the present disclosure generally envisions three types of frame modules: a slidable (or “floating”) frame module, an expansion frame module, and a fixed frame module. A fixed frame module involves frame members that are securely fixed to both footings and guide rails so as to prevent any frame member-footing movement and so as to prevent any frame-member-guide rail movement. In some examples, with respect to a longitudinal direction that follows a path of a rail conveyor system, a fixed frame module may be upstream of three or four slidable frame modules.

Next, an expansion frame module may be disposed downstream of the three or four slidable frame modules. Another three or four slidable frame modules may follow before reaching a second fixed frame module. Thus, from upstream to downstream, one example sequence of frame modules may be as follows: fixed-slidable-slidable-slidable-expansion-slidable-slidable-slidable-fixed, all of which are longitudinally spaced apart and interconnected only by guide rails and, in some cases, third rails or anti-derailment guides, as disclosed above. The use of fixed frame modules is possible because the slidable and expansion frame modules account for longitudinal expansion and contraction of the guide rails.

To help prevent injuries from workers' limbs being caught in a nip point between an advancing wheel and a guide rail, guards may be provided. One example low-profile guard includes a guard panel that is mounted outboard of a guide rail and has a height that spans upward from a level near a base of the guide rail up to at least the wheel axle. In some cases, the guard panel may extend to the top of the wheel or even higher. Such a guard panel may span longitudinally continuously outboard of each guide rail and may be supported on the modules by suitable brackets. Such guard panels may additionally be configured to shade the adjacent rails from the sun when the sun is at a relatively low angle, thus limiting differential heating (and thermal expansion) of guide rails on one side of the module compared to the other. The guard panel may also be configured to contain noise generated by the wheels running on the guide rails.

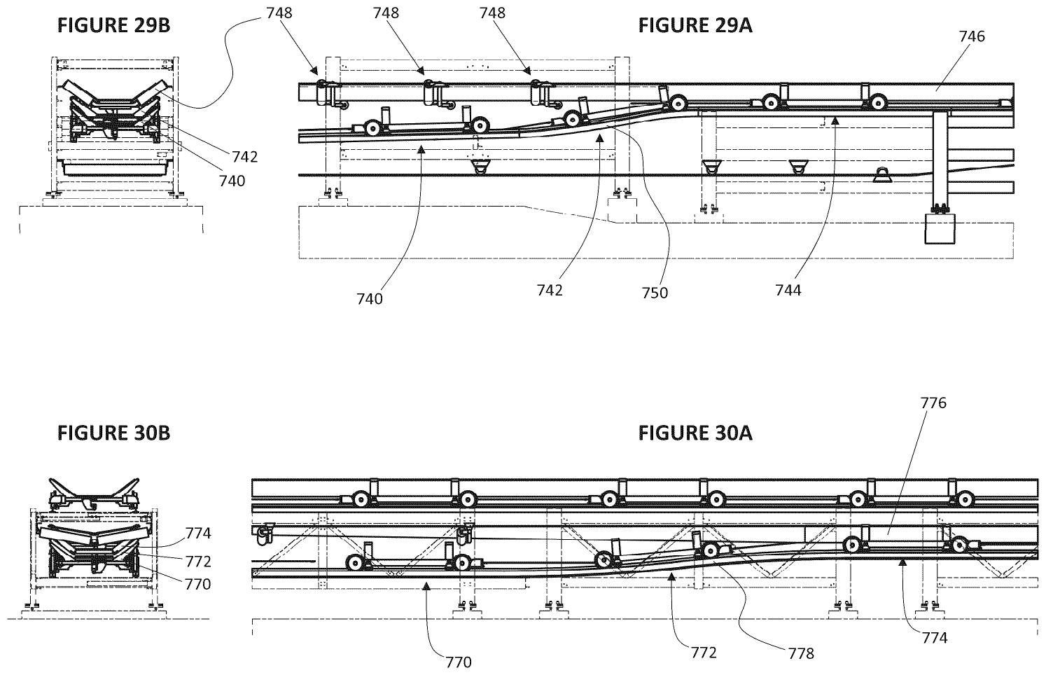

In a rail conveyor system, a carry belt may need to be separated from carriages on occasion, such as at the beginning and end of the track. Conventional rail conveyor systems achieve this necessary separation by lifting the carry belt up and away from the carriages at one or more longitudinal points along a path of the rail conveyor system. Lifting the carry belt up and away from the carriages may impose troublesome limitations in connection with belt concave curve radii, though. According to the present disclosure and FIGS. 29A and 29B, carriages 740, 742, 744 may be lowered down and away from a carry belt 746 that stays the course and is supported by top-supported idlers 748 having a low profile (e.g., smaller-than-usual diameter rollers).

One key to making the lowering of the carriages 740, 742, 744 possible is the reduced amount of tension in a cable that separates the carriages 740, 742, 744. The reduced amount of tension in the cable that separates the carriages 740, 742, 744 is due at least in part to safety springs like the safety spring 176 disclosed above. For instance, the amount of tension required to drive a group of carriages that have been separated from the carry belt through a turnaround loop can be greatly reduced so long as at least one safety spring is disposed between two of the carriages in the group in the turnaround loop. In effect, the safety spring provides a buffer throughout the turnaround loop that helps maintain the proper amount of tension (e.g., 20-30 kg, 25-35 kg, 30-40 kg, 35-45 kg, or 40-50 kg) between carriages without pulling the carriages out of the turnaround loop.

Further yet, attempting to lower carriages with prior art rail conveyor systems would be challenging because the tension in the cable that tows the carriages through a turnaround loop is higher and might cause the carriages to lift off the guide rails if the guide rails were to take a (relatively) rapid downward trajectory. Here, though, a reduced-tension cable, such as the cable 114 with the safety spring 176 that interconnects carriages as described with respect to FIGS. 4A-4C, enables lowering of the carriages 740, 742, 744 down and away from the carry belt 746 in a shorter distance, allowing that portion of the carry belt that is unsupported to be shorter than in a case where higher cable tensions are present.

To be clear, another key to separating the carry belt 746 from the carriages 740, 742, 744 is to minimize the longitudinal length of the carry belt 746 that is unsupported by either a carriage or an idler. The low profile and top-supported nature of the idlers 748 helps enable a steeper ramp 750, which consequently returns the carriages 740, 742, 744 beneath the carry belt 746 faster than a gradual ramp. These various features help minimize the distance-and hence the unsupported length of loaded carry belt 746-between the right-most top-supported idler 748 in FIG. 29A and a rear-most portion of the carriage 744 that has just been returned beneath the carry belt 746. In some cases, the ramp 750 may be at least 5%, 10%, 15%, 20%, 25%, 30%, 35%, 40%, 50%, 60%, 70%, 80%, 90%, or even 100% grade relative to the longitudinal members of the nearest frame module. Similarly, in some cases, the unsupported length of the loaded carry belt 746 may be less than 2, 3, 4, or 5 meters.

Unlike the scenario involving an upper, carry run and the loaded carry belt 746 shown in FIGS. 29A and 29B, returning carriages 770, 772, 774 to an unloaded return belt 776, as illustrated in FIGS. 30A and 30B, is slightly easier because the unloaded return belt 776 can be unsupported for a greater longitudinal distance. Consequently, a ramp 778 that returns the carriages 770, 772, 774 to the unloaded return belt 776 can be more gradual.

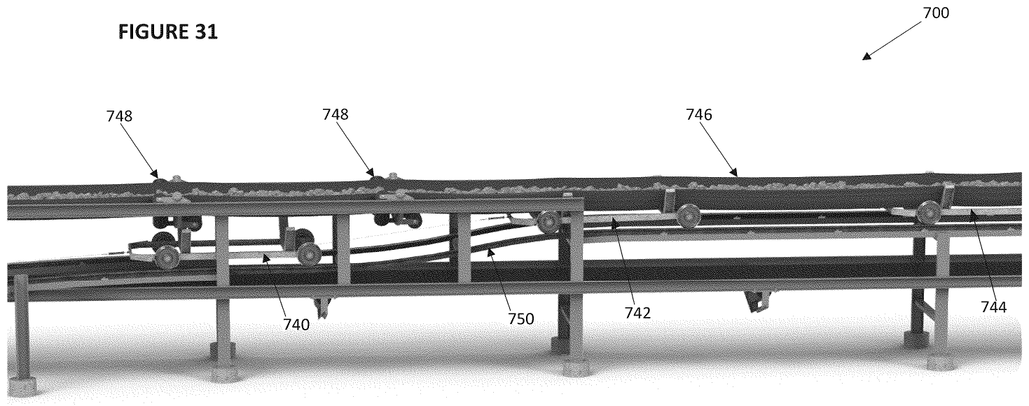

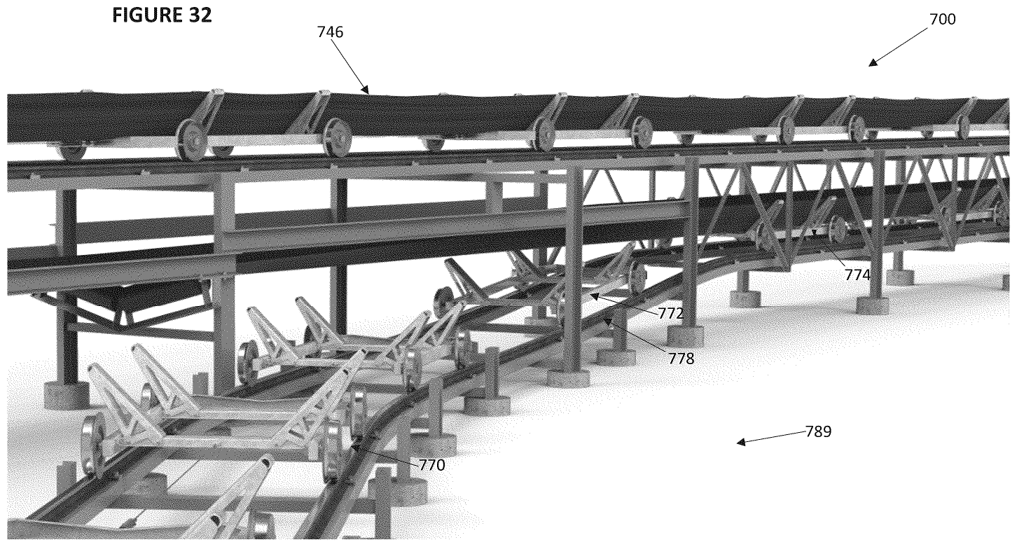

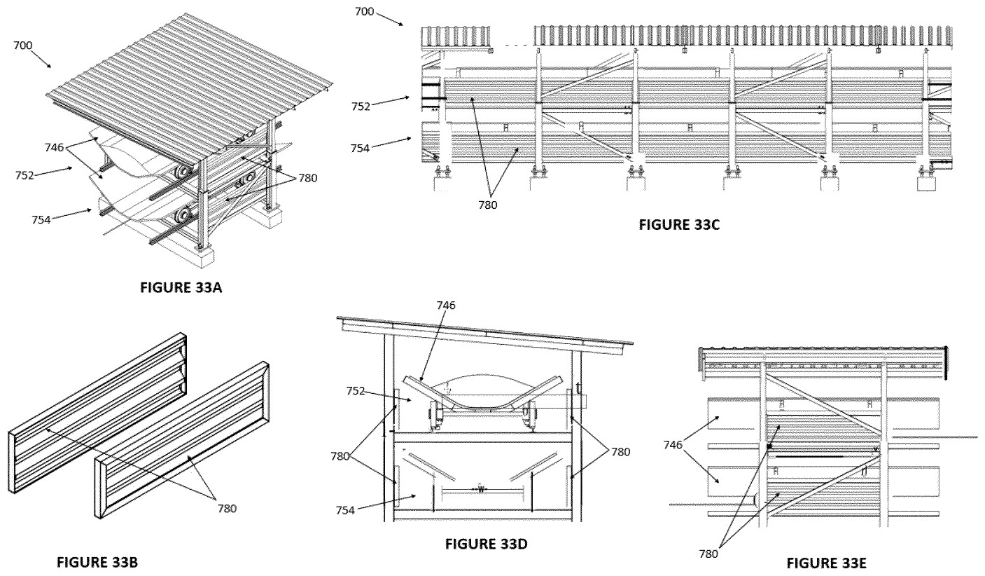

FIG. 31 shows another example frame section where carriages are being returned quickly to a loaded carry belt on an upper, carry run. FIG. 32 shows another example frame section where carriages are being returned gradually to an empty carry belt on a lower, return run.

Where used herein “at least one” may mean “one”, “some” or all”, without limitation. In some cases, it may be preferred to have only one of the described features, or more of them. It should also be understood that specific technical features shown or described may be combined with other technical features shown or described in various combinations and permutations, as desired or practical, without limitation. Thus, the particular examples depicted and shown are to be construed as non-limiting embodiments which may be practiced as shown/described (or altered according to preference-omitting certain features and employing certain others) in accordance with the teachings disclosed herein.

It should be further be understood that technical features or groups of technical features described herein may be mixed and matched, or varied in number, without limitation by those ordinarily skilled in the art as desired to achieve one or more or all of the technical effects associated therewith. Thus, various arrangements or configurations of the technical features disclosed are anticipated. For the sake of brevity, not every conceivable combination of two or more of the technical features described herein is expressly disclosed as a standalone embodiment.

What is claimed is:

1. A rail conveyor system (700) comprising:
guide rails that extend along a longitudinal path; and
carriages (100, 320, 322, 350, 352, 370, 418, 420, 422, 424, 478, 480, 482, 484, 740, 742, 744) that are supported by the guide rails and are configured to travel along the guide rails, characterized in that at least one the carriages includes at least two cradles (124, 126) which are configured to support a loaded and/or unloaded portion of a carry belt (746).

2. The rail conveyor system (700) according to claim 1, further comprising frame modules that are longitudinally spaced apart along the longitudinal path and which are configured to support the guide rails.

3. The rail conveyor system (700) according to claim 2, wherein the frame modules have a lower return run (308, 338, 534, 538, 606, 754) and an upper carry run (316, 346, 614, 752).

4. The rail conveyor system (700) according to any one of the preceding claims, further comprising a third rail (256, 306, 314, 344, 540, 542, 604) which is configured to cooperate with one or more anti-derailment devices (122, 254, 200B) provided to the carriages to minimize the risk of derailment.

5. The rail conveyor system (700) according to claim 4, wherein the third rail (256, 306, 314, 344, 540, 542, 604) is configured to only cooperate with the one or more anti-derailment devices (122, 254, 200B) in the event of a carriage derailment or loss or detachment of one or more carriage wheels (212).

6. The rail conveyor system (700) according to any of the preceding claims, comprising a third rail (306) provided to and extending along at least a portion of a lower return run (308), and a third rail (314) provided to and extending along at least a portion of an upper carry run (316).

7. The rail conveyor system (700) according to claim 4, wherein the third rail (256, 306, 314, 540, 542, 604) is provided between the guide rails.

8. The rail conveyor system (700) according to any one of claims 4-7, wherein the third rail (256, 306, 314, 344, 540, 542, 604) is fixed to a bracket (270) that is in turn fixed to a lateral-extending member (272) of a frame that supports the two primary guide rails (302, 304, 360, 362, 532, 536, 602, 608, 610).

9. The rail conveyor system (700) according to any one of the preceding claims, further comprising an anti-derailment guide (400, 402, 404, 406, 408, 410, 412, 414, 460, 462, 464, 466, 468, 470, 472, 474) which is configured to cooperate with wheels (112, 112A, 112B, 112C, 112D), and/or axles (160, 162) of the carriages to minimize the risk of derailment.

10. The rail conveyor system (700) according to any one of the preceding claims, further comprising footings (318, 360A, 360B, 546, 616, 718), wherein the frame modules further include a fixed frame module where frame members of the fixed frame module are securely fixed to both the footings (318, 360A, 360B, 546, 616, 718) and the guide rails.

11. The rail conveyor system (700) according to any one of preceding claims, further comprising footings (318, 360A, 360B, 546, 616, 718), wherein the frame modules further include a slidable frame module (300, 358, 426, 438, 486, 498, 520, 704, 706) where frame members of the slidable frame module (300, 358, 426, 438, 486, 498, 520, 704, 706) are securely fixed to the guide rails but can slide at least to some degree longitudinally relative to the footings (318, 360A, 360B, 546, 616, 718).

12. The rail conveyor system (700) according to claim 11, further comprising one or more slidable connections (544) configured to slidably attach the slidable frame module (520) to one or more footings (546) that are secured to, planted in, and/or staked to the ground.

13. The rail conveyor system (700) according to any one of preceding claims, further comprising footings (318, 360A, 360B, 546, 616, 718), wherein the frame modules further include an expansion frame module (330, 428, 488, 600, 702) where frame members of the expansion frame module are securely fixed to the footings (318, 360A, 360B, 546, 616, 718) but are slidably coupled to the guide rails so that the guide rails can expand and contract at expansion joints (430, 432, 434, 436, 490, 492, 494, 496, 618, 620, 622).

14. The rail conveyor system (700) according to any one of preceding claims, wherein the frame modules comprise fixed frame modules, slidable frame modules (300, 358, 426, 438, 486, 498, 520, 704, 706), and expansion frame modules (330, 428, 488, 600, 702), wherein the frame modules are sequenced such that one or more of expansion frame modules or slidable frame modules are disposed between fixed frame modules to accommodate thermal expansion of the guide rails.

15. The rail conveyor system (700) according to any one of the preceding claims, wherein at least one of the carriages (100) comprises one or more outrigger brackets (200A, 200B, 200C, 200D).

16. The rail conveyor system (700) according to claim 15, wherein the one or more outrigger brackets (200A, 200B, 200C, 200D) are provided with a slider pad (202) positioned adjacent a location where a wheel (112) of said one of the carriages (100) contacts one of the guide rails, the slider pad (202) being configured to reduce the risk of carriage derailment in the event the wheel (112) becomes detached from said one of the carriages (100).

17. The rail conveyor system (700) according to claim 15 or 16, wherein the one or more outrigger brackets (200A, 200B, 200C, 200D) are provided with a lateral wheel (204) which is configured, at least through some sections of track, to roll along at least one of the guide rails and maintain a lateral position of a carriage relative to said at least one of the guide rails, particularly as the carriage travels through curves.

18. The rail conveyor system (700) according to any one of claims 15-17, wherein the one or more outrigger brackets (200A, 200B, 200C, 200D) are provided between wheels (212) on one or both sides of said at least one of the carriages (100) along a first (104) and/or second (106) longitudinal member of a frame (102)

19. The rail conveyor system (700) according to any one of the preceding claims, further comprising a cable (114, 380) coupled to and/or extending between adjacent carriages.

20. The rail conveyor system (700) according to claim 19, further comprising one or more safety springs (176) attached to the cable (114, 380), and being configured to provide a buffer throughout a turnaround loop (789) and/or help maintain a proper amount of tension between carriages without pulling the carriages out of the turnaround loop (789) or off of the guide rails.

21. The rail conveyor system (700) according to claim 19, wherein the cable has an elasticity sufficient to maintain a positive cable tension in the cable (114, 380) in a turnaround loop (789).

22. The rail conveyor system (700) according to claim 19, further comprising an arrangement of one or more tension or compression springs with the cable (114, 380) to maintain a positive cable tension in the cable (114, 380) in a turnaround loop (789).

23. The rail conveyor system (700) according to any one of the preceding claims, wherein at least one of the carriages comprises a wheel (112) having a core section (220) and a flanged section (222)

24. The rail conveyor system (700) according to claim 23, wherein the core section (220) comprises a conical face (224) configured to enable the wheel (112) to spin at different rates when the at least one of the carriages travels through a curve along portions of the rail conveyor system (700) where the guide rails are curved.

25. The rail conveyor system (700) according to claim 23 or 24, wherein the flanged section (222) of the wheel (112) includes a composite annulus (226) that is sandwiched between the core section (220) and a steel backing ring (228).

26. The rail conveyor system (700) according to claim 25, wherein the composite annulus (226) comprises a material having a coefficient of friction with steel which is substantially lower than a coefficient of friction between steel and steel to prevent the flanged section (222) from climbing up a guide rail and/or discourage carriage derailment.

27. The rail conveyor system (700) according to claim 25 or 26, wherein the composite annulus (226) is joined to the flanged section (222) at a radial extremity of where the core section (220) terminates.

28. The rail conveyor system (700) according to any one of claims 25-27, wherein the composite annulus (226) is configured to have a face that is smoothly contiguous with an annular radius, fillet, blend, or curved transition surface extending between the core section (220) and the flanged section (222).

29. The rail conveyor system (700) according to any one of claims 25-28, wherein the composite annulus (226) comprises an outer diameter that is enlarged relative to the outer diameter of the core section (220) to an extent that that the flanged section (222) projects below an enlarged upper rail head portion (657) of at least one of the guide rails.

30. The rail conveyor system (700) according to any one of the preceding claims, further comprising an upper sliding member (652, 664A) provided between a clamp body (648) of a clip (640) and one of the guide rails (608A).

31. The rail conveyor system (700) according claim 30, wherein the upper sliding member (652, 664A) comprises at least two separate components contacting each other at a low-friction sliding surface defined therebetween.

32. The rail conveyor system (700) according claim 30 or 31, wherein the upper sliding member (652, 664A) comprises a polymeric (e.g., UHMWPE) material, and/or a metallic material which is configured with properties for reducing resistance to sliding against the guide rails, or which comprises a coefficient of friction which is less than the coefficient of friction of the material of the guide rails.

33. The rail conveyor system (700) according to any one of the preceding claims, further comprising a base sliding member (652) provided below a base (656) of at least one of the guide rails (608A).

34. The rail conveyor system (700) according to claim 33, wherein the base sliding member (654, 664A) comprises at least two separate components contacting each other at a low-friction sliding surface defined therebetween.

35. The rail conveyor system (700) according claim 34, wherein the base sliding member (654, 664A) comprises a polymeric (e.g., UHMWPE) and/or metallic material which is configured with properties for reducing resistance to sliding against the guide rails, or which comprises a coefficient of friction which is less than the coefficient of friction of the material of the guide rails.

36. The rail conveyor system (700) according to any one of the preceding claims, wherein some of the carriages are supported on upper guide rails (302, 304) and travel above other ones of the carriages which are supported on lower guide rails (310, 312).

37. The rail conveyor system (700) according to any one of the preceding claims, further comprising dampening means (170) provided to at least one of the carriages.

38. The rail conveyor system (700) according to any one of the preceding claims, wherein at least one of the carriages comprises an axle beam (160) through which an axle (162) extends.

39. The rail conveyor system (700) according to claim 38, wherein the axle beam (160) supports first (104) and second (106) longitudinal members of a carriage frame (102) by means of damping means (170) interposed between the axle beam (160) and the first (104) and second (106) longitudinal members.

40. The rail conveyor system (700) according to any one of the preceding claims, wherein at least one of the carriages comprises a live axle (162) that rotates with wheels thereon.

41. The rail conveyor system (700) according to any one of the preceding claims, wherein at least one of the carriages comprises a dead shaft axle (162) that does not rotate.

42. The rail conveyor system (700) according to claim 41, wherein the dead shaft axle (162) supports first (104) and second (106) longitudinal members of a carriage frame (102) by means of damping means (170) interposed between the dead shaft axle (162) and the first (104) and second (106) longitudinal members.

43. The rail conveyor system (700) according to any one of the preceding claims, wherein at least a portion of a carry belt (746) is supported by idlers (748).

44. The rail conveyor system (700) according to claim 43, wherein the idlers (748) are provided in an area where a portion of the carry belt (746) is in transition between being supported by a carriage (740) and being supported by an end idler.

45. The rail conveyor system (700) according to claim 43 or 44, wherein the idlers (748) are provided in an area downstream of where carriages (740, 742, 744) are lowered down away from a loaded portion of the carry belt (746) along an upper carry run.

46. The rail conveyor system (700) according to any one of claims 43-45, wherein the idlers (748) are top-supported and/or have a low profile.

47. The rail conveyor system (700) according to any one of the preceding claims, further comprising a guard (780) configured to cover a nip point between advancing wheels (112) of the carriages (112) and at least one of the guide rails.

48. The rail conveyor system (700) according to claim 47, wherein the guard (780) is provided as a guard panel spanning upward from a level near a base (656) of said at least one of the guide rails up to at least a wheel axle (162) on one of the carriages, and/or up to a top of a wheel (112) on one of the carriages.

49. The rail conveyor system (700) according to any one of the preceding claims, wherein the frame modules are interconnected by the guide rails such that the guide rails extend between frame modules and/or bridge gaps between ends of adjacent frame modules.

50. The rail conveyor system (700) according to any of the preceding claims wherein a third rail (256, 306, 314, 344, 540, 542, 604) extends for at least a portion of the length of the guide rails either continuously or discontinuously.

51. The rail conveyor system (700) according to any one of the preceding claims, wherein the cradles (124, 126) are supported along longitudinal members (104, 106) of a carriage frame (102).

52. The rail conveyor system (700) according to any one of the preceding claims, wherein the cradles (124, 126) are longitudinally spaced apart from one another in relation to a longitudinal direction (LD).

53. The rail conveyor system (700) according to any one of the preceding claims, wherein at least one of the cradles (124, 126) is longitudinally spaced apart from and/or longitudinally offset from a first (108) and/or second crossmember (110), in relation to a longitudinal direction (LD).

54. The rail conveyor system (700) according to any one of the preceding claims, wherein a first one (124) of the cradles (124, 126) is longitudinally spaced apart from and/or longitudinally offset from a first crossmember (108), in relation to a longitudinal direction (LD).

55. The rail conveyor system (700) according to any one of the preceding claims, wherein a second one (126) of the cradles (124, 126) is longitudinally spaced apart from and/or longitudinally offset from a second crossmember (110) provided to the carriage, in relation to a longitudinal direction (LD).

56. The rail conveyor system (700) according to any one of the preceding claims, wherein the cradles (124, 126) are offset from an adjacent wheel axis or axis of an adjacent carriage axle (162) by a distance which is sufficient to provide one or more lateral wheels (204) or slider pads (202) in substantial alignment with the cradles (124, 126) without interference from wheels (112) or other carriage portions.

57. The rail conveyor system (700) according to any one of the preceding claims, wherein the cradles (124, 126) are offset from an adjacent wheel axis or axis of an adjacent carriage axle (162) by a distance which is sufficient to expose a gauge-side surface of an upper rail head portion (657) of guide rails to lateral wheels (204).

58. A rail conveyor system (700) comprising:
guide rails that extend along a longitudinal path; and
carriages (100, 320, 322, 350, 352, 370, 418, 420, 422, 424, 478, 480, 482, 484, 740, 742, 744) that are supported by the guide rails and are configured to travel along the guide rails, characterized in that the rail conveyor further comprises frame modules wherein at least two of the frame modules are longitudinally spaced apart along the longitudinal path, and the frame modules are interconnected by and/or support the guide rails.

59. The rail conveyor system (700) according to claim 58, wherein the frame modules are interconnected by the guide rails such that the guide rails extend between frame modules and/or bridge gaps between ends of adjacent frame modules

60. The rail conveyor system (700) according to any one of the preceding claims, comprising a ramp (750) provided to an upper carry run (316, 346, 614, 752) which is defined by an elevation change of upper guide rails provided to the upper carry run (316, 346, 614, 752); the ramp (750) being configured to drop the carriages away from a loaded upper portion of a carry belt (746).

61. The rail conveyor system (700) according to any one of the preceding claims, comprising a ramp (778) provided to a lower return run (308, 338, 606, 754) which is defined by an elevation change of lower guide rails provided to the lower return run (308, 338, 606, 754); the ramp (778) being configured to raise the carriages towards an unloaded lower portion of a carry belt (746) as they move away from a turnaround loop (789).

62. The rail conveyor system (700) according to any one of the preceding claims, wherein a spacing between adjacent frame modules is configured to allow a predetermined amount of differential settlement between the adjacent frame modules.

63. The rail conveyor system (700) according to any one of the preceding claims, wherein a spacing between adjacent frame modules is configured to accommodate a deflection of at least one of the guide rails spanning therebetween.

64. The rail conveyor system (700) according to any one of the preceding claims, wherein a spacing between adjacent frame modules is configured to allow at least some deflection of at least one of the guide rails and/or accommodate a vertical and/or horizontal curvature of at least one of the guide rails.

65. The rail conveyor system (700) according to any one of the preceding claims, wherein at least one of the frame modules comprises a set of two or more lateral members (526) which are configured to support the guide rails, and a spacing provided between the lateral members (526) measured in a longitudinal direction (LD) which is configured to allow one more of the guide rails to conform elastically to a vertical and/or horizontal curvature in the longitudinal direction (LD).

66. The rail conveyor system (700) according to claim 65, wherein at least one of the lateral members (526) comprises adjustment means and is configured to be adjusted relative to other components of said at least one of the frame modules.

67. The rail conveyor system (700) according to claim 66, wherein the adjustment means is provided adjacent to where said at least one of the lateral members (526) joins another portion of said at least one of the frame modules and/or adjacent to a footing (546).

68. The rail conveyor system (700) according to claim 66 or 67, wherein the adjustment means is configured to provide a range of vertical adjustment between a portion of said at least one of the frame modules and said at least one of the lateral members (526) which sufficiently accommodates an offset of one or more of the guide rails due to a vertical and/or horizontal curvature of said one or more of the guide rails in the longitudinal direction (LD).

69. The rail conveyor system (700) according to any one of claims 66-68, wherein said adjustment means comprises height-setting means selected from the group consisting of: a slotted connection, a tongue that is sandwiched between plates, one or more jacks, or one or more adjustable brackets.

70. The rail conveyor system (700) according to any one of the preceding claims, wherein at least one (608B) of the guide rails is slidably retained to a lateral member (646) using a clip (640) provided on opposite sides of the at least one (608B) of the guide rails.

71. The rail conveyor system (700) according to claim 70, wherein, said clip (640) comprises a clamp body (648), one or more fasteners (650), and an upper sliding member (652),

72. The rail conveyor system (700) according to any one of the preceding claims, further comprising a base sliding member (654) disposed above the lateral member (646) and below a base (656) of the at least one (608B) of the guide rails such that the base (656) is slidably retained to the lateral member (646), such that sliding may occur between the lateral member (646) and base (656).

73. The rail conveyor system (700) according to any one of the preceding claims, wherein a length of at least one of the carriages is between 1.30 and 2.5 times its width.

74. The rail conveyor system (700) according to any one of the preceding claims, wherein a longitudinal member (104, 106) of a frame (102) of least one of the carriages is more than 1.3 times the length of a crossmember (108, 110) of the frame (102).

75. The rail conveyor system (700) according to any one of the preceding claims, wherein the longitudinal member (104, 106) is more than 1.50, 1.75, 2.00, 2.25, or 2.50 times the length of a crossmember (108, 110) on the frame (102).

76. The rail conveyor system (700) according to any one of the preceding claims, wherein at least one of the carriages include one or more bumpers (118, 120) at a front (116) of the carriage, wherein bumpers (118, 120) which are configured to prevent the wheels 112A, 112B, 112C, 112D or the frame 102 from snagging vertical structural columns.

77. The rail conveyor system (700) according to any one of the preceding claims, comprising one or more bumpers provided adjacent ends of longitudinal members (104, 106) of a frame (102) of one of the carriages.

78. The rail conveyor system (700) according to any one of the preceding claims,
wherein the guide rails are supported on frame modules (358, 300, 330), including at least two adjacent frame modules being spaced apart from each other in a longitudinal direction (LD) such that a gap exists between respective ends of the at least two adjacent frame modules;
wherein a portion of one of the guide rails at one of the gaps between the at least two adjacent frame modules comprises an unsupported section length (701); and
wherein the unsupported section length (701) is within ÷20% of a distance between guide rail support beams (526) on at least one of the adjacent frame modules, said distance between guide rail support beams (526) being measured in the longitudinal direction (LD).

79. The rail conveyor system (700) according to any one of the preceding claims,
wherein the guide rails are supported on frame modules (358, 300, 330), including at least two adjacent frame modules being spaced apart from each other in a longitudinal direction (LD) such that a gap exists between respective ends of the at least two adjacent frame modules;
wherein a portion of one of the guide rails at one of the gaps between the at least two adjacent frame modules comprises an unsupported section length (701); and
wherein the unsupported section length (701) is greater than 5 times a section height (659) of a guide rail (340, 342).

80. The rail conveyor system (700) according to claim 79, wherein the unsupported section length (701) is greater than 10 times the section height (659) of a guide rail (340, 342).

81. The rail conveyor system (700) according to claim 80, wherein the unsupported section length (701) is greater than 20 times the section height (659) of a guide rail (340, 342).

82. The rail conveyor system (700) according to claim 81, wherein the unsupported section length (701) is greater than 30 times the section height (659) of a guide rail (340, 342).
